(19) United States
(12) Patent Application Publication
(10) Pub. No.: US 2025/0048161 A1
(43) Pub. Date: Feb. 6, 2025

(54) SIDELINK POSITIONING INTEGRITY RESULTS

(71) Applicant: Lenovo (Singapore) Pte. Limited, Singapore (SG)

(72) Inventors: Robin Rajan Thomas, Frankfurt (DE); Hyung-Nam Choi, Ottobrunn (DE)

(73) Assignee: Lenovo (Singapore) Pte. Limited, Singapore (SG)

(21) Appl. No.: 18/788,546

(22) Filed: Jul. 30, 2024

Related U.S. Application Data
(60) Provisional application No. 63/516,860, filed on Jul. 31, 2023.

(51) Int. Cl. H04W 24/10; H04W 64/00; H04W 72/25

(52) U.S. Cl. CPC H04W 24/10; H04W 64/00; H04W 72/25

(57) ABSTRACT

Various aspects of the present disclosure relate to sidelink positioning integrity results. An apparatus, such as a network entity for wireless communication, transmits to a UE, a request message to request sidelink positioning integrity KPIs and sidelink positioning integrity results, and the request message includes at least an indication of TIR and a protection level. The network entity receives, from the UE, a response message that includes the requested sidelink positioning integrity KPIs and the sidelink positioning integrity results. The network entity determines whether sidelink positioning integrity conditions of a computed location estimate are satisfied based at least in part on the received sidelink positioning integrity KPIs and the sidelink positioning integrity results.

### RELATED APPLICATION

This application claims priority to U.S. Provisional Application Ser. No. 63/516,860 filed Jul. 31, 2023 entitled “Sidelink Positioning Integrity Results,” the disclosure of which is incorporated by reference herein in its entirety.

### TECHNICAL FIELD

The present disclosure relates to wireless communications, and more specifically to sidelink positioning.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A wireless communications system can provide techniques for determining device position, such as a location of a UE. However, current device positioning techniques may be imprecise and result in inaccurate indications of device location. Positioning integrity refers to the measure of trust and associated procedures that ensure an estimated position calculated by a positioning calculation entity can be trusted with a high degree of certainty. There is currently a lack of functionality to support sidelink positioning integrity given the different UE roles and modes of integrity operation, such as for UE-based and/or location management function (LMF)-based sidelink positioning integrity.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE receives, from a communication device, a request message to request sidelink positioning integrity key performance indicators (KPIs) and sidelink positioning integrity results, where the request message includes at least an indication of target integrity risk (TIR) and a protection level. The UE transmits, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

In some implementations of the method and apparatuses described herein, the communication device includes at least one of a location server, a server UE, or an anchor UE. The UE is at least one of a target-UE, a server UE, or an anchor UE. The sidelink positioning integrity KPIs include at least one of a time to alert (TTA) or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The at least one processor is configured to cause the UE to transmit, to the communication device, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The at least one processor is configured to cause the UE to receive real-time sidelink positioning integrity information. The real-time sidelink positioning integrity information includes one or more do not use (DNU) flags associated with sidelink positioning assistance data elements including one or more of sidelink positioning reference signal (SL-PRS) resource configurations, anchor UE location information, system frame number (SFN) initialization time, direct frame number (DFN) initialization time, real time difference (RTD) synchronization information, inter-UE synchronization information, sidelink antenna reference point (ARP) location information, sidelink AOD beam information, or SL-PRS transmission-reception point (TRP) antenna information. Different SL-PRS resource hierarchies include at least one of sidelink positioning frequency layers, sidelink TRPs, SL-PRS resource pools, SL-PRS resource sets, or SL-PRS resources.

Some implementations of the method and apparatuses described herein may further include a processor for wireless communication. The processor receives a request message to request sidelink positioning integrity KPIs and sidelink positioning integrity results, where the request message includes at least an indication of TIR and a protection level. The processor transmits a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

In some implementations of the method and apparatuses described herein, the sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The at least one controller is configured to cause the processor to transmit an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The at least one controller is configured to cause the processor to receive real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

Some implementations of the method and apparatuses described herein may further include a method performed by a UE, the method comprising: receiving, from a communication device, a request message to request sidelink positioning integrity KPIs and sidelink positioning integrity results, the request message including at least an indication of TIR and a protection level; and transmitting, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

In some implementations of the method and apparatuses described herein, the communication device includes at least one of a location server, a server UE, or an anchor UE. The UE is at least one of a target-UE, a server UE, or an anchor UE. The sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The method further comprising transmitting, to the communication device, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The method further comprising causing the UE to receive real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

Some implementations of the method and apparatuses described herein may further include a network entity for wireless communication. The network entity transmits, to a UE, a request message to request sidelink positioning KPIs and sidelink positioning integrity results, where the request message includes at least an indication of TIR and a protection level. The network entity receives, from the UE, a response message that includes the requested sidelink positioning integrity KPIs and the sidelink positioning integrity results. The network entity determines whether sidelink positioning integrity conditions of a computed location estimate are satisfied based at least in part on the received sidelink positioning integrity KPIs and the sidelink positioning integrity results.

In some implementations of the method and apparatuses described herein, the network entity includes at least one of a location server, a server UE, or an anchor UE. The UE is at least one of a target-UE, a server UE, or an anchor UE. The sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical level value, an azimuth AOA protection level value, or a zenith AOA protection level value. The at least one processor is configured to cause the network entity to receive, from the UE, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The at least one processor is configured to cause the network entity to transmit real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

Some implementations of the method and apparatuses described herein may further include a method performed by a network entity, the method comprising: transmitting, to a UE, a request message to request sidelink positioning integrity KPIs and sidelink positioning integrity results, the request message including at least an indication of TIR and a protection level; receiving, from the UE, a response message that includes the requested sidelink positioning integrity KPIs and the sidelink positioning integrity results; and determining whether sidelink positioning integrity conditions of a computed location estimate are satisfied based at least in part on the received sidelink positioning integrity KPIs and the sidelink positioning integrity results.

In some implementations of the method and apparatuses described herein, the network entity includes at least one of a location server, a server UE, or an anchor UE. The UE is at least one of a target-UE, a server UE, or an anchor UE. The sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical level value, an azimuth AOA protection level value, or a zenith AOA protection level value. The method further comprising receiving, from the UE, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The method further comprising transmitting real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

### BRIEF DESCRIPTION OF THE DRAWINGS

FIG. 1 illustrates an example of a wireless communications system in accordance with aspects of the present disclosure.

FIG. 2 illustrates an example of a system for NR beam-based positioning, in accordance with aspects of the present disclosure.

FIG. 3 illustrates an example of absolute and relative positioning scenarios, in accordance with aspects of the present disclosure.

FIG. 4 illustrates an example of a multi-cell round trip time (RTT) procedure, in accordance with aspects of the present disclosure.

FIG. 5 illustrates an example of a system for relative range estimation using a gNB RTT positioning framework, in accordance with aspects of the present disclosure.

FIG. 6 illustrates an example of a relationship between the positioning error (PE), protection level (PL), alert limit (AL), misleading information (MI), and hazardous misleading information (HMI), in accordance with aspects of the present disclosure.

FIG. 7 illustrates an example of Stanford diagram for integrity events, in accordance with aspects of the present disclosure.

FIGS. 8-19 illustrate examples of procedures for sidelink positioning integrity and results, in accordance with aspects of the present disclosure.

FIG. 20 illustrates an example of a UE in accordance with aspects of the present disclosure.

FIG. 21 illustrates an example of a processor in accordance with aspects of the present disclosure.

FIG. 22 illustrates an example of a network equipment (NE) in accordance with aspects of the present disclosure.

FIG. 23 illustrates a flowchart of a method performed by a UE in accordance with aspects of the present disclosure.

FIG. 24 illustrates a flowchart of a method performed by a NE in accordance with aspects of the present disclosure.

FIG. 25 illustrates a flowchart of a method performed by a location server in accordance with aspects of the present disclosure.

FIG. 26 illustrates a flowchart of a method performed by a UE in accordance with aspects of the present disclosure.

FIG. 27 illustrates a flowchart of a method performed by a NE in accordance with aspects of the present disclosure.

### DETAILED DESCRIPTION

A wireless communications system enables UE-assisted and UE-based positioning methods in the 3GPP positioning framework. Positioning integrity refers to the measure of trust and associated procedures that ensure an estimated position calculated by a positioning calculation entity can be trusted with a high degree of certainty. UE-based global navigation satellite system (GNSS) integrity allows a UE to determine, and report to a location server, the integrity results of a calculated position determined using GNSS positioning methods. Additionally, support for radio access technology (RAT)-dependent integrity methods on the downlink (DL) and uplink (UL) has been introduced, which measures the trust of RAT-dependent positioning techniques, such as DL-time difference of arrival (TDOA), DL-angle of departure (AOD), multi-round trip time (RTT), UL-TDOA, and UL-AOA.

The sidelink (SL) positioning framework supports varying target positioning requirements across different use cases, such as for vehicle-to-everything (V2X), public safety, industrial Internet of things (IIoT), commercial use cases, and other applications. The sidelink positioning is implemented to determine the absolute or relative position of a UE by utilizing sidelink positioning methods, such as sidelink RTT-type methods, including single-sided and double-sided RTT, SL-AOA, and SL-TDOA. The positioning is based on a new SL-positioning reference signal (PRS) that is transmitted over the PC5 interface and supported in all coverage scenarios, such as in-coverage, partial coverage, and out-of-coverage scenarios, and for PC5-only-based and joint PC5-Uu-based operation scenarios. A new protocol denoted as sidelink positioning protocol (SLPP) is introduced for exchanging the sidelink positioning related information between UEs over the PC5 interface.

There is currently a lack of functionality to support sidelink positioning integrity given the different UE roles and modes of integrity operation, such as for UE-based and/or location management function (LMF)-based sidelink positioning integrity. However, given that sidelink positioning may be utilized for some safety critical use cases, it is imperative that the integrity and reliability of the positioning estimates using sidelink positioning be ensured. Currently there are no procedures that are supported to enable UE-based computation of the integrity of a given positioning estimate. Further, there is currently a lack of specified functionality to support the transfer and processing of sidelink positioning integrity KPIs and integrity results, particularly for UE-based sidelink positioning integrity.

Aspects of the disclosure are directed to sidelink positioning integrity, such as for enhanced sidelink techniques and procedures that enable sidelink positioning integrity, and procedures to collect and determine error bound measurement and assistance data error information. The techniques described herein support various aspects of sidelink positioning integrity, such as support for UE-based sidelink positioning integrity with and without location server involvement, support for LMF-based sidelink positioning integrity, and enabling UE-based and LMF-based sidelink positioning integrity using measurement error and/or assistance data error bound information and associated parameters. The support for UE-based sidelink positioning integrity with and without location server involvement provides for sidelink positioning integrity in all coverage scenarios, including in-coverage, partial coverage, and out-of-coverage. The support for LMF-based sidelink positioning integrity is applicable to in-coverage and partial coverage scenarios.

Aspects of the disclosure are directed to sidelink positioning integrity results, such as for enhanced sidelink techniques and procedures that enable sidelink positioning result reporting (e.g., as a positioning reporting message) and improving positioning integrity on location estimates derived using sidelink. The techniques described herein support various aspects of sidelink positioning integrity results, such as support for integrity result reporting in different coverage scenarios, and providing for explicit and/or implicit indications when the sidelink positioning integrity does not fulfil the target integrity requirements. This disclosure provides techniques for supporting the necessary procedures to transfer sidelink positioning integrity KPIs and integrity results, as well as improve the subsequent integrity computations through the provision of sidelink positioning real-time integrity alerts. An aspect provides for the transfer of real-time integrity information needed to improve the positioning integrity or avoid a loss in positioning integrity. An application of the use of real-time integrity information is the use of do not use (DNU) flags for SL-PRS resources or other assistance data elements.

By utilizing the described techniques for sidelink positioning integrity and results, a higher degree of confidence in a computed positioning estimate at a given time can be attained, which supports safety-related applications with accurate and low latency sidelink positioning. Aspects of the present disclosure are described in the context of a wireless communications system.

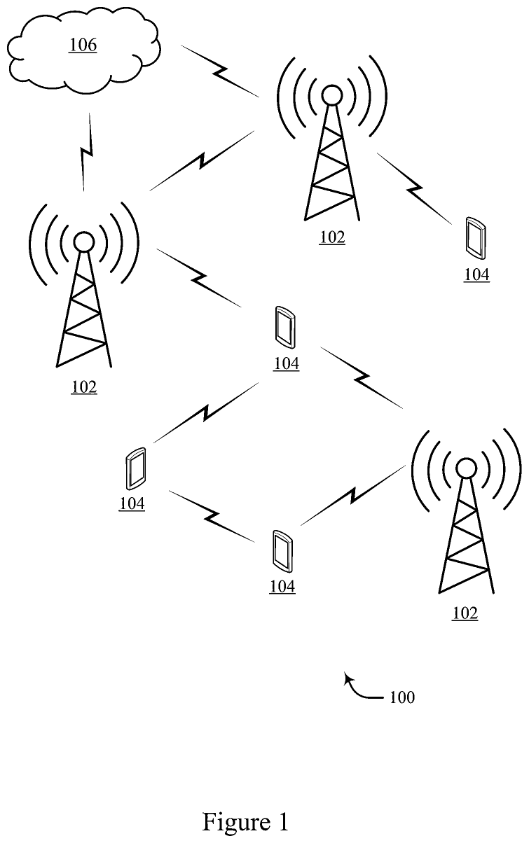

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (CNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 (e.g., a target-UE) transmits, to a NE 102 (e.g., a base station, network entity, location server), a configuration request message to request sidelink positioning integrity information, where the configuration request message includes at least integrity service parameters. The UE 104 receives, from the NE 102, a response message that includes the requested sidelink positioning integrity information. The UE 104 determines sidelink positioning integrity of a computed location estimate based at least in part on the received sidelink positioning integrity information. In another implementation, a NE 102 receives, from a UE 104, a configuration request message to request sidelink positioning integrity information, where the configuration request message includes at least integrity service parameters. The NE 102 transmits, to the UE 104, a response message that includes the requested sidelink positioning integrity information, from which sidelink positioning integrity of a computed location estimate is determinable based at least in part on the sidelink positioning integrity information.

According to implementations, one or more of the NEs 102 and the UEs 104 are operable to implement various aspects of the techniques described with reference to the present disclosure. For example, a NE 102 (e.g., a base station, network entity, location server) transmits, to a UE 104, a request message to request sidelink positioning KPIs and sidelink positioning integrity results, where the request message includes at least an indication of TIR and a protection level. The NE 102 receives, from the UE 104, a response message that includes the requested sidelink positioning integrity KPIs and the sidelink positioning integrity results. The NE 102 determines whether sidelink positioning integrity conditions of a computed location estimate are satisfied based at least in part on the received sidelink positioning integrity KPIs and the sidelink positioning integrity results. In another implementation, a UE 104 receives, from a NE 102, a request message to request sidelink positioning integrity KPIs and sidelink positioning integrity results, where the request message includes at least an indication of TIR and a protection level. The UE 104 transmits, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

With reference to positioning requirements, NR positioning based on NR Uu signals and stand-alone (SA) architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Currently 3GPP Release 17 positioning has defined the positioning performance requirements for commercial and IIoT use cases as follows:

| Positioning Error | Commercial | IIoT |
|---|---|---|
| Horizontal Positioning | (<1 m) for 90% | (<0.2 m) for 90% |
| | of UEs | of UEs; |
| Vertical Positioning | (<3 m) for 90% | (<1 m) for 90% |
| | of UEs | of UEs |
| Physical layer latency for | (<10 ms) | (<10 ms) |
| position estimation of UE | | |
| End-to-End Latency for | (<100 ms) | (<100 ms, in the |
| position estimation of UE | | order of 10 ms |
| | | is desired) |

For sidelink positioning in Release 18, various requirements were defined capturing a variety of use cases, as listed in the following table:

| SL | | | | |
|---|---|---|---|---|
| Positioning | | | | |
| KPIs | V2X | Public Safety | IIoT | Commercial |
| Horizontal | Set A (similar to | 1 m for 90% of | Set A: 1 m | 1 m for 90% of |
| Positioning | “Set 2” defined in | UEs (absolute or | for 90% of | UEs (absolute |
| Accuracy | [2]): 1.5 m for | relative) | UEs (absolute | or relative) |
| | 90% of UEs | | or relative) | |
| | (absolute or | | Set B: 0.2 m | |
| | relative) | | for 90% of | |
| | Set B (similar to | | UEs (absolute | |
| | “Set 3” defined in | | or relative) | |
| | [2]): 0.5 m for | | | |
| | 90% of UEs | | | |
| | (absolute or | | | |
| | relative) | | | |
| Vertical | Set A: 3 m for | 2 m (absolute or | Set A: 1 m | 2 m for 90% of |
| Positioning | 90% of UEs | relative between | for 90% of | UEs (absolute |
| Accuracy | (absolute or | 2 UEs) for 90% | UEs (absolute | or relative) |
| | relative) | of UEs | or relative) | |
| | Set B: 2 m for | 0.3 m (relative | Set B: 0.2 m | |
| | 90% of UEs | positioning | for 90% of | |
| | (absolute or | change for 1 UE) | UEs (absolute | |
| | relative) | for 90% of UEs | or relative) | |
| Relative | — | Up to 30 km/h | Up to 30 km/h | Up to 30 km/h |
| Speed | | | | |

| | |
|---|---|
| Angle | Set A: Y = ±15° for 90% of the UEs |
| Accuracy | Set B: Y = ±8° for 90% of the UEs |

NOTE 1:
For evaluated SL positioning methods, the performance results are described in terms of whether each of the two requirements are satisfied, and the percentile of UEs satisfying the target positioning accuracy for a requirement that may not be satisfied with 90%.
NOTE 2:
Target positioning requirements may not necessarily be reached for all scenarios and deployments
NOTE 3:
All positioning techniques may not achieve all positioning requirements in all scenarios.

The supported UE positioning techniques are listed as methods in the following table:

| | | UE-assisted, | NG-RAN | |
|---|---|---|---|---|
| Method | UE-based | LMF-based | node assisted | SUPL |
| A-GNSS | Yes | Yes | No | Yes (UE-based and UE-assisted) |
| OTDOA ^{Notes1,2} | No | Yes | No | Yes (UE-assisted) |
| E-CID ^{Note 4} | No | Yes | Yes | Yes for E-UTRA (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE1}:
This includes TBS positioning based on PRS signals.
^{NOTE2}:
In this version of the specification only observed time difference of arrival (OTDOA) based on LTE signals is supported.
^{NOTE 4}:
This includes Cell-ID for NR method.
^{NOTE 5}:
In this version of the specification is for TBS positioning based on metropolitan beacon system (MBS) signals.

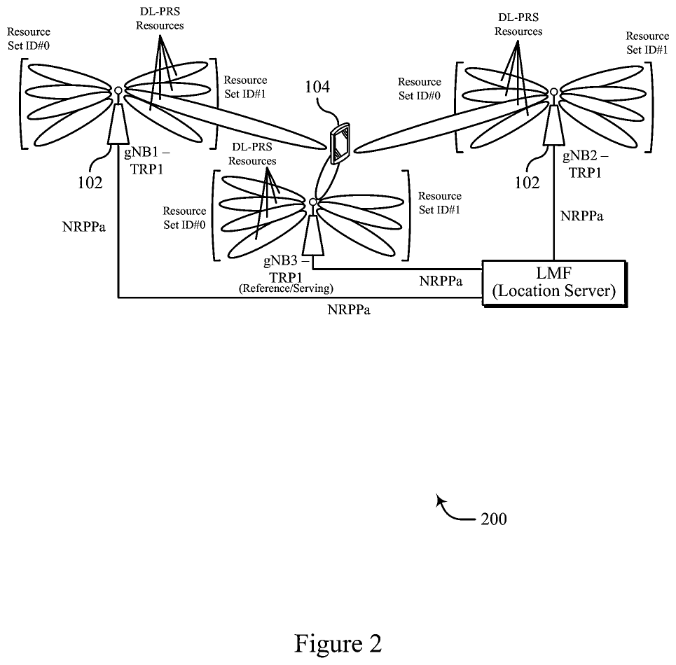

Separate positioning techniques as indicated in the table above can be currently configured and performed based on the requirements of the LMF and UE capabilities. The transmission of Uu (uplink and downlink) PRSs enable the UE to perform UE positioning-related measurements to enable the computation of a UE's absolute location estimate and are configured per transmission reception point (TRP), where a TRP may include a set of one or more beams. A conceptual overview is illustrated in FIG. 2.

FIG. 2 illustrates an example of system 200 for NR beam-based positioning in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (e.g., a TRP). Similarly, UE positioning measurements, such as RSTD and PRS reference signal received power (RSRP) measurements are made between beams (e.g., between a different pair of downlink (DL) PRS resources or DL PRS resource sets) as opposed to different cells as was the case in LTE. In addition, there are additional uplink positioning methods for the network to exploit in order to compute the target-UE's location.

The tables below show the reference signal (RS) to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on the GNSS, inertial measurement unit (IMU) sensor, wireless local area network (WLAN), and Bluetooth technologies for performing target device (UE) positioning.

TABLE
UE measurements to enable RAT-
dependent positioning techniques.

| | | To facilitate support |
|---|---|---|
| DL/UL Reference | | of the positioning |
| Signals | UE Measurements | techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel.16 DL PRS/ | UE Rx-Tx time difference | Multi-RTT |
| Rel.16 SRS for | | |
| positioning | | |
| Rel. 15 SSB/CSI-RS | SS-RSRP(RSRP for RRM), | NR E-CID |
| for RRM | SS-RSRQ(for RRM), | |
| | CSI-RSRP (for RRM), | |
| | CSI-RSRQ (for RRM), | |
| | SS-RSRPB (for RRM) | |

TABLE
gNB measurements to enable RAT-dependent
positioning techniques.

| | | To facilitate support |
|---|---|---|
| DL/UL Reference | | of the positioning |
| Signals | gNB Measurements | techniques |
| Rel. 16 SRS for | UL RTOA | UL-TDOA |
| positioning | | |
| Rel. 16 SRS for | UL SRS-REFERENCE | UL-TDOA, UL-AoA, |
| positioning | SIGNAL RECEIVED | Multi-RTT |
| | POWER (RSRP) | |
| Rel. 16 SRS for | gNB Rx-Tx time | Multi-RTT |
| positioning, Rel. 16 | difference | |
| DL PRS | | |
| Rel. 16 SRS for | AoA and ZoA | UL-AoA, Multi-RTT |
| positioning | | |

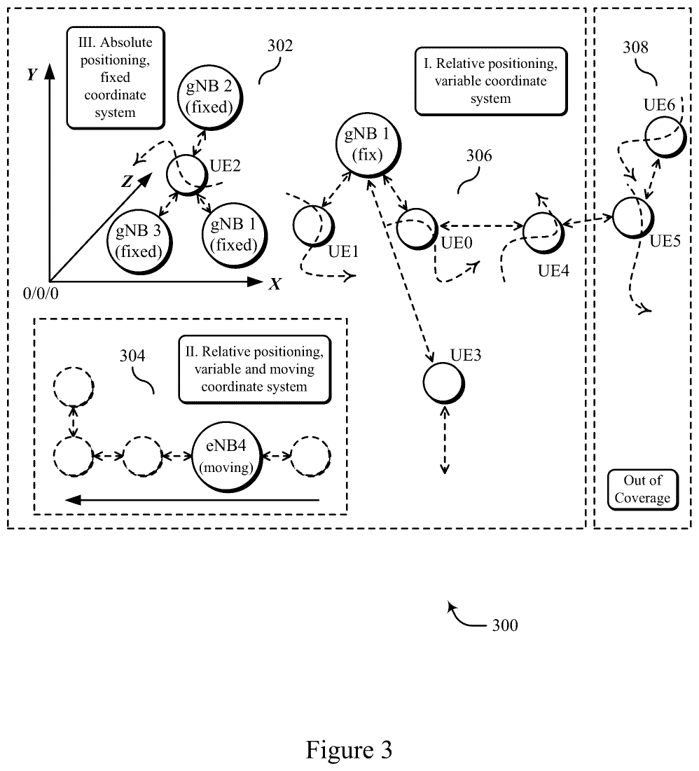

FIG. 3 illustrates an example 300 of absolute and relative positioning scenarios in accordance with aspects of the present disclosure. The network devices described with reference to example 300 may use and/or be implemented with the wireless communications system 100 and include UEs 104 and network entities 102 (e.g., eNB, gNB). The example 300 is an overview of absolute and relative positioning scenarios as defined in the architectural (stage 1) specifications using three different co-ordinate systems, including (III) a conventional absolute positioning, fixed coordinate system at 302; (II) a relative positioning, variable and moving coordinate system at 304; and (I) a relative positioning, variable coordinate system at 306. Notably, the relative positioning, variable coordinate system at 306 is based on relative device positions in a variable coordinate system, where the reference may be always changing with the multiple nodes that are moving in different directions. The example 300 also includes a scenario 308 for an out of coverage area in which UEs need to determine relative position with respect to each other.

The relative positioning, variable and moving coordinate system at 304 may support relative lateral position accuracy of 0.1 meters between UEs supporting V2X applications, and may support relative longitudinal position accuracy of less than 0.5 meters for UEs supporting V2X applications for platooning in proximity. The relative positioning, variable coordinate system at 306 may support relative positioning between one UE and positioning nodes within 10 meters of each other. The relative positioning, variable coordinate system at 306 may also support vertical location of a UE in terms of relative height/depth to local ground level.

Various RAT-dependent positioning techniques are supported in Release 16 and Release 17, such as DL-TDOA, DL-AOD, Multi-RTT, enhanced cell-ID (E-CID)/NR E-CID, UL-TDOA, and UL-AOA. The downlink time difference of arrival (DL-TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AOD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

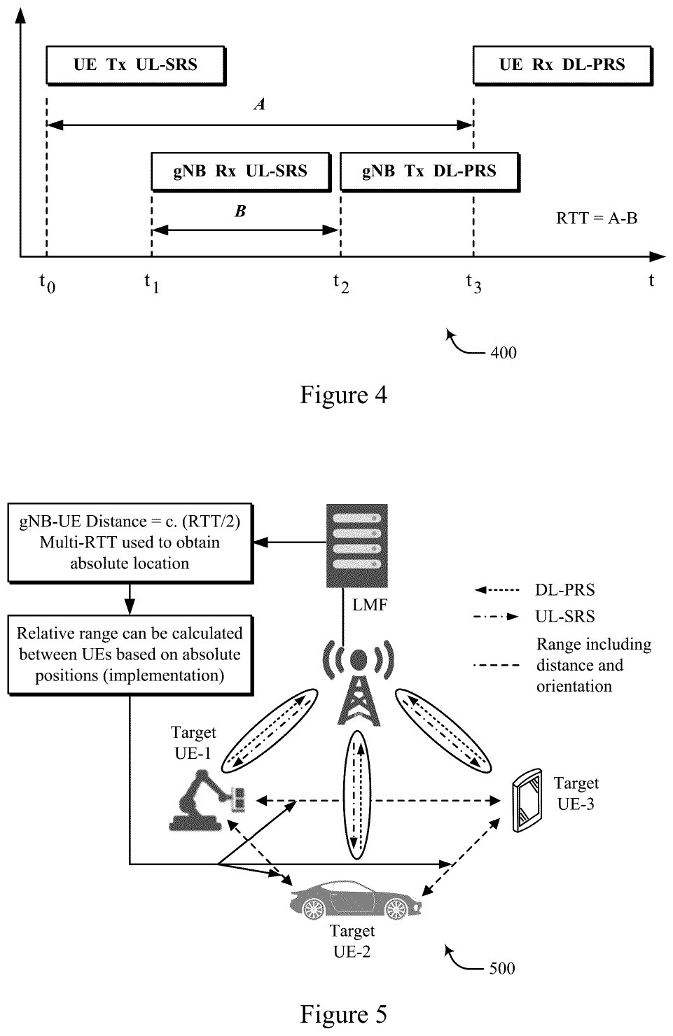

FIG. 4 illustrates an example 400 of a multi-cell RTT procedure in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink SRS RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in the table above.

FIG. 5 illustrates an example of a system 500 for relative range estimation using a gNB RTT positioning framework in accordance with aspects of the present disclosure. The system 500 illustrates the relative range estimation using the existing single gNB RTT positioning framework. The location server (e.g., LMF) can configure measurements to the different UEs, and then the target-UEs can report their measurements in a transparent way to the location server. The location server can compute the relative distance between two UEs. This approach is high in latency and is not an efficient method in terms of procedures and signaling overhead.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the RRC protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-relative time-of-arrival (RTOA) (and optionally UL SRS-RSRP) at multiple reception points (RPs) of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, terrestrial beacon system (TBS) positioning, and motion sensor positioning. Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, Global Navigation Satellite System (GLONASS), and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and PRSs. The UE measures received TBS signals, optionally aided by assistance data, to calculate its location or to send measurements to the positioning server for position calculation.

Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

Different downlink measurements used for RAT-dependent positioning techniques include DL PRS-RSRP, DL RSTD, and UE Rx-Tx Time Difference. The following measurement configurations may be used: four (4) Pair of DL RSTD measurements can be performed per pair of cells, and each measurement is performed between a different pair of DL PRS Resources/Resource Sets with a single reference timing; and eight (8) DL PRS RSRP measurements can be performed on different DL PRS resources from the same cell.

The DL PRS reference signal received power (DL PRS-RSRP) is defined as the linear average over the power contributions (in [W]) of the resource elements that carry DL PRS reference signals configured for RSRP measurements within the considered measurement frequency bandwidth. For frequency range 1, the reference point for the DL PRS-RSRP is the antenna connector of the UE. For frequency range 2, DL PRS-RSRP is measured based on the combined signal from antenna elements corresponding to a given receiver branch. For frequency range 1 and 2, if receiver diversity is in use by the UE, the reported DL PRS-RSRP value is not lower than the corresponding DL PRS-RSRP of any of the individual receiver branches. DL PRS-RSRP is applicable for RRC_CONNECTED intra-frequency and RRC_CONNECTED inter-frequency.

The DL RSTD is the downlink relative timing difference between the positioning node j and the reference positioning node i, defined as T_{SubframeRxj}−T_{SubframeRxi}, where T_{SubframeRxj} is the time when the UE receives the start of one subframe from positioning node j, and T_{SubframeRxi} is the time when the UE receives the corresponding start of one subframe from positioning node i that is closest in time to the subframe received from positioning node j. Multiple DL PRS resources can be used to determine the start of one subframe from a positioning node. For frequency range 1, the reference point for the DL RSTD is the antenna connector of the UE. For frequency range 2, the reference point for the DL RSTD is the antenna of the UE. The DL RSTD is applicable for RRC_CONNECTED intra-frequency and RRC_CONNECTED inter-frequency.

The UE receive-transmit (Rx-Tx) time difference is defined as TUE-RX-TUE-TX, where TUE-RX is the UE received timing of downlink subframe #i from a positioning node, defined by the first detected path in time, and TUE-TX is the UE transmit timing of uplink subframe #j that is closest in time to the subframe #i received from the positioning node. Multiple DL PRS resources can be used to determine the start of one subframe of the first arrival path of the positioning node. For frequency range 1, the reference point for TUE-RX measurement shall be the Rx antenna connector of the UE and the reference point for TUE-TX measurement shall be the Tx antenna connector of the UE. For frequency range 2, the reference point for TUE-RX measurement shall be the Rx antenna of the UE and the reference point for TUE-TX measurement shall be the Tx antenna of the UE. The UE Rx-Tx time difference is applicable for RRC_CONNECTED intra-frequency and RRC_CONNECTED inter-frequency.

The DL PRS reference signal received path power (DL PRS-RSRPP) is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP is the antenna connector of the UE. For frequency range 2, DL PRS-RSRPP is measured based on the combined signal from antenna elements corresponding to a given receiver branch. DL PRS-RSRPP is applicable for RRC_CONNECTED and RRC_INACTIVE.

TABLE
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined as |
| | the power of the linear average of the channel response at the i-th path delay |
| | of the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be the |
| | antenna connector of the UE. For frequency range 2, DL PRS-RSRPP shall be |
| | measured based on the combined signal from antenna elements corresponding |
| | to a given receiver branch. |
| Applicable for | RRC_CONNECTED |
| | RRC_INACTIVE |

With reference to integrity KPIs, the KPIs for positioning integrity are defined to include target identity risk (TIR), alert limit (AL), time to alert (TTA), and integrity availability. The TIR is a probability that the positioning error exceeds the alert limit without warning the user within the required TTA. Note that the TIR is usually defined as a probability rate per some time unit (e.g., per hour, per second, or per independent sample). The alert limit is the maximum allowable positioning error such that the positioning system is available for the intended application. If the positioning error is beyond the alert limit, then the positioning system should be declared unavailable for the intended application to prevent loss of positioning integrity. Note that when the alert limit bounds the positioning error in the horizontal plane or on the vertical axis, then it is called a horizontal alert limit (HAL) or a vertical alert limit (VAL), respectively. The TTA is the maximum allowable elapsed time from when the positioning error exceeds the alert limit until the function providing positioning integrity annunciates a corresponding alert. The integrity availability is the percentage of time that the protection level (PL) is below the required alert limit.

The integrity protection level is a real-time upper bound on the positioning error at the required degree of confidence, where the degree of confidence is determined by the TIR probability. The PL is defined as a statistical upper-bound of the positioning error (PE) that ensures the probability per unit of time of the true error is greater than the AL, and the PL is less than or equal to the AL, for longer than the TTA, is less than the required TIR, i.e., the PL satisfies the following inequality:

Prob per unit of time [((PE>AL) & (PL<=AL)) for longer than TTA]<required TIR.

Noting that when the PL bounds the positioning error in the horizontal plane or on the vertical axis then it is called the HPL or the VPL respectively, and further noting that a specific equation for the PL is not specified, as this is implementation-defined. For the PL to be considered valid, it must simply satisfy the inequality above.

The PL is used to indicate the positioning system availability, such as when the PL is greater than the AL, then the system is considered unavailable (see Stanford Diagram FIG. 7). The PL establishes a more rigorous upper bound on the positioning error by taking into consideration the additional feared events which have a lower occurrence (i.e., lower TIR) compared to the nominal events considered in the standard accuracy estimate alone. The lower the TIR, the more feared events that need to be considered.

Fault feared events are those which are intrinsic to the positioning system and typically caused by the malfunction of an element of the positioning system (e.g., constellation or ground network failures). Fault-free feared events occur when the positioning system inputs are erroneous, but the event is not caused by a malfunction of the positioning system. In the GNSS context for example, fault-free feared events include nominal effects experienced every day such as poor satellite geometry, larger atmospheric gradients, and signal interruption, all of which can degrade positioning performance without causing the system to fail. A common limitation of existing industry functional safety standards is that only the fault conditions are considered. In practice, however, the fault-free conditions also have a material contribution to the total integrity risk budget and must therefore be monitored.

The PL is necessary to ensure all potential faults and fault-free events down to the required TIR are considered. It bounds the tails of the distribution with higher certainty (per unit of time) and provides a measure for ensuring only those positions whose positioning integrity has been validated within the TIR are included in the final positioning solution. By contrast, the standard accuracy estimate only considers a subset of feared events up to a nominal percentile (e.g., 2-sigma, 95%), based on the entire distribution of estimated position errors.

With reference to the relationship between the PL and the KPIs, the TIR is a design constraint for a positioning system and represents the probability that a positioning error exceeds the AL, but the positioning system fails to alert the user within the required period of time (i.e., TTA). In practice, the TIR is very small. For example, <10-7/hr TIR translates to one failure permitted every 10 million hours (equivalent to 1142 years approximately).

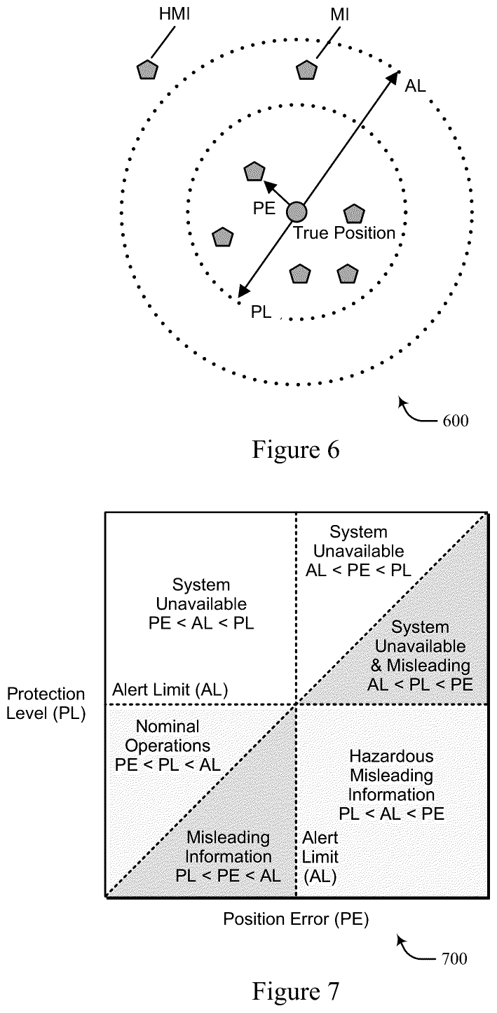

FIG. 6 illustrates an example 600 of a relationship between the positioning error, protection level, alert limit, misleading information, and hazardous misleading information in accordance with aspects of the present disclosure. In this example, positioning integrity system failures are known as integrity events, and the integrity events occur when the positioning system outputs HMI. The HMI occurs when the positioning is declared available, yet the actual positioning error exceeds the AL without annunciating an alert within the required TTA. The MI occurs when the positioning system is declared available, yet the actual positioning error exceeds the PL. Typically, positioning systems are designed to tolerate some level of MI, provided the system can continue to operate safely within the AL. To properly monitor for integrity in the positioning system, both the fault and fault-free conditions which potentially lead to MI or HMI need to be characterized for the network and the UE.

FIG. 7 illustrates an example of a Stanford diagram 700 for integrity events in accordance with aspects of the present disclosure. In this example, the Stanford diagram 700 provides a useful representation for interpreting the relationship between the positioning integrity KPIs and PL. It should be noted that the positioning error (PE) in this diagram is the difference between the true position and the estimated position, computed by the positioning device. In practice, the true position is not known. In context, the conditions represented above the diagonal line (Nominal Operations, System Unavailable) mean the positioning system is operating as intended by correctly detecting when the system should or should not be available.

The conditions represented below the diagonal line mean the system is not operating as intended. These conditions are what the positioning integrity system is designed to protect against (i.e., by monitoring the necessary fault and fault-free events to protect against MI or HMI for a given TIR). Furthering the concept, the TIR is equivalent to the probability per unit time of HMI, corresponding to the lower left block (i.e., HMI) in the Stanford Diagram. The rate of MI (corresponding to the lower left triangle), while undesirable, does not contribute towards the TIR.

In practice, positioning integrity systems are designed to tolerate some level of MI or HMI for a period of time within the TTA, without exceeding the TIR. This framework underpins the PL definition in this study and is particularly important for systems with communication latency, such as 3GPP NR, given assistance data can be monitored and sent by the network (i.e., the basis of this study). Sufficient time is therefore needed to signal that a fault is present. There is nothing prohibiting the TTA being set to zero for instantaneous detection, however a grace period can be accommodated to allow some level of functionality to be offloaded to the network when the network is utilized. Hence, the TTA depends on the overall positioning integrity system design (including 3GPP and non-3GPP elements) and is specified by the positioning system owner (e.g., a vehicle manufacturer) alongside the TIR and AL.

Interpretations when the system is available (PL<AL) include Nominal Operations (PE<PL): the solution is available and operating safely without an integrity event. Misleading Information (PE>PL & PE<AL): the solution is available but contains an MI integrity event due to PE>PL. It is still operating safely given PE does not exceed the AL. Hazardous Misleading Information (PE>PL & PE>AL): the solution is available but contains an HMI integrity event due to PE>AL. It is still declared safe (PL<AL) when it should not have been.

Interpretations when the system is unavailable (PL>AL) include System Unavailable, False Alert (PE<PL & PE<AL): the solution is unavailable but is a false alert integrity event, given PE<AL. System Unavailable (PE<PL & PE>AL): the solution is unavailable and operating as intended without an integrity event given PE>AL was properly detected. System Unavailable and Misleading (PE>PL & PE>AL): the solution is unavailable and contains a MI (PE>PL) integrity event.

With reference to GNSS integrity, for integrity operation, the network will ensure that (in an equation 8.1.1a-1):

P(Error>Bound for longer than TTA|NOT DNU)<=Residual Risk+IRallocation

for all values of IRallocation in the range irMinimum<=IRallocation<=irMaximum, and for all listed errors which have corresponding integrity assistance data available and where the corresponding DNU flag(s) are set to false. The integrity risk probability is decomposed into a constant residual risk component provided in the assistance data as well as a variable IRallocation component that corresponds to the contribution from the bound according to the bound formula (in an equation 8.1.1a-2). IRallocation may be chosen freely by the client based on the desired bound, therefore the network should ensure that the equation above (equation 8.1.1a-1) holds for all possible choices of IRallocation. The residual risk and IRallocation components may be mapped to fault and fault-free cases respectively, but the implementation is free to choose any other decomposition of the integrity risk probability into these two components.

The validity time of the integrity bounds is set as equal to twice the state space representation (SSR) update interval for the given SSR assistance data message (i.e., the time period between the SSR epoch time and the SSR epoch time plus twice the SSR update interval in the GPS time scale. The equation above (equation 8.1.1a-1) holds for all assistance data that has been issued and is still within its validity period. If this condition cannot be met, then the corresponding DNU flag must be set. Further, the equation holds at any epochs for which assistance data is provided. Providing assistance data without the integrity service alert information element (IE) or real time integrity IEs is interpreted as a DNU=FALSE condition. For any bound that is still valid (within its validity time), the network ensures that the integrity service alert and/or real time integrity IEs are also included in the provided assistance data if needed to satisfy the condition in the equation above (equation 8.1.1a-1). It is up to the implementation how to handle epochs for which integrity results are desired but there are no DNU flag(s) available (e.g., the time to alert (TTA) may be set such that there is a “grace period” to receive the next set of DNU flags.

Only those satellites for which the GNSS integrity assistance data are provided are monitored by the network and can be used for integrity related applications. For Error: an error is the difference between the true value of a GNSS parameter (e.g., ionosphere, troposphere, etc.), and its value as estimated and provided in the corresponding assistance data. For Bound: the integrity bounds provides the statistical distribution of the residual errors associated with the GNSS positioning corrections (e.g., RTK, SSR, etc.). Integrity bounds are used to statistically bound the residual errors after the positioning corrections have been applied. The bound is computed according to the bound formula (i.e., defined in an equation 8.1.1a-2 below). The bound formula describes a bounding model including a mean and standard deviation (e.g. paired over-bounding Gaussian). The bound may be scaled by multiplying the standard deviation by a K factor corresponding to an IRallocation, for any desired IRallocation within the permitted range.

The bound for a particular error is computed according to the following formula (in an equation 8.1.1a-2) with a mean value and standard deviation for the specific error:

$$Bound = mean + K * stdDev$$

$$K = normInv ( IRallocation / 2 )$$

$$irMinimum <= IRallocation <= irMaximum$$

For TTA, the maximum allowable elapsed time from when the Error exceeds the bound until a DNU flag must be issued. The DNU flag(s) corresponding to a particular error as per a Table 8.1.2.1b-1 (in TS 38.305, Stage 2 functional specification of UE positioning in NG-RAN (Release 17)). Where multiple DNU flags are specified, the DNU condition in equation 8.1.1a-1 is present when any of the flags are true (logical OR of the flags). The residual risk is the component of the integrity risk provided in the assistance data as per the Table 8.1.2.1b-1. This may correspond to the fault case risk, but the implementation is permitted to allocate this component in any way that satisfies the equation 8.1.1a-1. The residual risk is the probability of onset which is defined per unit of time and represents the probability that the feared event begins. Each residual risk is accompanied by a mean duration which represents the expected mean duration of the corresponding feared event and is used to convert the probability of onset to a probability that the feared event is present at any given time, (as in equation 8.1.1a-3):

P(Feared Event is Present)=Mean Duration*Probability of Onset of Feared Event

For irMinimum, and irMaximum, the minimum and maximum allowable values of IRallocation may be chosen by the client, provided as service parameters from the network according to integrity service parameters. For correlation times, the minimum time interval beyond which two sets of GNSS assistance data parameters for a given error can be considered to be independent from one another.

Table: Mapping of GNSS Integrity Parameters

| | | Integrity Fields | | | | |
|---|---|---|---|---|---|---|
| | GNSS | | Integrity | Integrity | | Integrity |
| | Assistance | Integrity | Bounds | Bounds | Residual | Correlation |
| Error | Data | Alerts | (Mean) | (StdDev) | Risks | Times |
| Orbit | SSR Orbit | Real-Time | Mean Orbit | Variance Orbit | Probability | Orbit Range Error |
| | Corrections | Integrity | Error | Error | of Onset of | Correlation Time |
| | | (see Clause | Mean Orbit | Variance Orbit | Constellation | Orbit Range Rate |
| | | 8.1.2.1.8) | Rate Error | Rate Error | Fault | Error Correlation |
| | | | (Calculated | (Calculated | Probability | Time |
| | | | according to | according to | of Onset of | |
| | | | Equation | Equation | Satellite | |
| | | | 8.1.2.1.21-1) | 8.1.2.1.21-1) | Fault | |
| Clock | SSR Clock | | Mean Clock | Standard | Mean | Clock Range |
| | Corrections | | Error | Deviation Clock | Constellation | Error Correlation |
| | | | Mean Clock | Error | Fault | Time |
| | | | Rate Error | Standard | Duration | Clock Range Rate |
| | | | | Deviation Clock | Mean | Error Correlation |
| | | | | Rate Error | Satellite | Time |
| Code Bias | SSR Code | | Mean Code | Standard | Fault | |
| | Bias | | Bias Error | Deviation Code | Duration | |
| | | | Mean Code | Bias Error | | |
| | | | Bias Rate | Standard | | |
| | | | Error | Deviation Code | | |
| | | | | Bias Rate Error | | |
| Phase Bias | SSR Phase | | Mean Phase | Standard | | |
| | Bias | | Bias Error | Deviation Phase | | |
| | | | Mean Phase | Bias Error | | |
| | | | Bias Rate | Standard | | |
| | | | Error | Deviation Phase | | |
| | | | | Bias Rate Error | | |
| Ionosphere | SSR STEC | Ionosphere | Mean | Standard | Probability | Ionosphere Range |
| | Correction | DNU | Ionosphere | Deviation | of Onset of | Error Correlation |
| | | | Error | Ionosphere Error | Ionosphere | Time |
| | | | Mean | Standard | Fault | Ionosphere Range |
| | | | Ionosphere | Deviation | Mean | Rate Error |
| | | | Rate Error | Ionosphere Rate | Ionosphere | Correlation Time |
| | | | | Error | Fault | |
| | | | | | Duration | |
| Troposphere | SSR | Troposphere | Mean | Standard | Probability | Troposphere |
| Vertical | Gridded | DNU | Troposphere | Deviation | of Onset of | Range Error |
| Hydro Static | Corrections | | Vertical Hydro | Troposphere | Troposphere | Correlation Time |
| Delay | | | Static Delay | Vertical Hydro | Fault | Troposphere |
| | | | Error | Static Delay | Mean | Range Rate Error |
| | | | Mean | Error | Troposphere | Correlation Time |
| | | | Troposphere | Standard | Fault | |
| | | | Vertical Hydro | Deviation | Duration | |
| | | | Static Delay | Troposphere | | |
| | | | Rate Error | Vertical Hydro | | |
| | | | | Static Delay | | |
| | | | | Rate Error | | |
| Troposphere | | | Mean | Standard | | |
| Vertical | | | Troposphere | Deviation | | |
| Wet Delay | | | Vertical Wet | Troposphere | | |
| | | | Delay Error | Vertical Wet | | |
| | | | Mean | Delay Error | | |
| | | | Troposphere | Standard | | |
| | | | Vertical Wet | Deviation | | |
| | | | Delay Rate | Troposphere | | |
| | | | Error | Vertical Wet | | |
| | | | | Delay Rate | | |
| | | | | Error | | |

TABLE
Error sources for LMF-based and UE-based positioning integrity modes

| Positioning | | | | | |
|---|---|---|---|---|---|
| Integrity | | | | | |
| Mode | DL TDOA | UL TDOA | Multi-RTT | UL AoA | DL AoD |
| LMF-based | RSTD | RTOA | UE Rx-Tx time | Angle of arrival | TRP location |
| (as defined | measurement | measurement | difference | measurement | DL-PRS |
| in Table | TRP location | TRP location | measurement | TRP location | RSRPP of the |
| 9.4.1.1.1 in | Inter-TRP | Inter-TRP | gNB Rx-Tx time | ARP location (e.g., | first path or |
| TR 38.857) | synchronization | synchronization | difference | ARPLocationInformation) | RSRP |
| | (can be caused | (can be caused | measurement | | |
| | in part by errors | in part by errors | TRP location | | |
| | in SFN | in SFN | | | |
| | initialization | initialization | | | |
| | time.) | time.) | | | |
| UE-based | TRP location | | | | TRP location |
| (as defined | (e.g., NR-TRP- | | | | (e.g., NR- |
| in Table | LocationInfo) | | | | TRP- |
| 9.4.1.1.1 in | Inter-TRP | | | | LocationInfo) |
| TR 38.857) | synchronization | | | | |
| | (e.g., NR-RTD- | | | | |
| | Info) | | | | |

The following are some non-limiting examples of entities and terminologies that may be referred to in this disclosure. An initiator device can initiate a sidelink positioning/ranging session, and may be implemented as a network entity (e.g., gNB, LMF, etc.) a UE, a roadside unit (RSU), etc. A responder device can respond to a SL positioning/ranging session from an initiator device, and may be implemented as a network entity (e.g., gNB, LMF), a UE, a roadside unit (RSU), etc. A target-UE can represent a UE of interest a position of which (e.g., absolute and/or relative) is to be obtained by an entity such as a network, another UE, and/or by the target-UE itself.

Sidelink positioning refers to positioning a UE using reference signals transmitted over sidelink (e.g., PC5 interface) to obtain absolute position, relative position, ranging information, etc. Ranging refers to a determination of a distance and/or direction between a UE and another entity, e.g., anchor UE. An anchor UE refers to a UE supporting positioning of a target-UE, e.g., by transmitting and/or receiving reference signals for positioning, providing positioning-related information, etc., over the sidelink interface. An anchor UE may additionally or alternatively be referred to as sidelink reference UE, a reference UE, etc.

An assistant UE refers to a UE supporting ranging/sidelink between a sidelink reference UE and target-UE over PC5, such as in scenarios where direct ranging/sidelink positioning between the sidelink reference UE/anchor UE and the target-UE may not be supported. Measurement results of ranging/sidelink positioning between the assistance UE and the sidelink reference UE, and that between the assistance UE and the target-UE can be determined and used to derive the ranging/sidelink positioning results between target-UE and sidelink reference UE.

A sidelink positioning server UE refers to a UE enabling location calculation for sidelink positioning and ranging-based service. The sidelink positioning server UE can interact with other UE over PC5 to calculate the location of a target-UE. A target-UE and/or sidelink reference UE can act as sidelink positioning server UE. A sidelink positioning client UE refers to a third-party UE (e.g., other than sidelink reference UE and/or the target-UE) which can initiate a ranging/sidelink positioning service request on behalf of an application residing on the sidelink positioning client UE. In implementations a sidelink positioning client UE does not have to support ranging/sidelink positioning capability but a communication between the sidelink positioning client UE and a sidelink reference UE or target-UE may be established (e.g., via PC5, 5GC, etc.) for transmission of a service request and a positioning result.

A sidelink positioning node may refer to a network entity and/or device/UE participating in a sidelink positioning session, e.g., LMF (location server), gNB, UE, RSU, anchor UE, initiator UE, responder UE, etc. A configuration entity refers to a network node and/or other device/UE capable of configuring time-frequency resources and related sidelink positioning configurations. A sidelink positioning server UE may serve as a configuration entity.

Aspects of the described techniques for this disclosure include solutions and implementations for sidelink positioning integrity. In aspects of sidelink positioning integrity, this disclosure details solutions that enable integrity computation of location estimates derived from sidelink RAT-dependent positioning in order to enhance SL positioning reliability. Implementations include procedures to support UE-based sidelink positioning integrity, procedures to support LMF-based sidelink positioning integrity, enabling the collection and determination of sidelink measurement error for computing the sidelink positioning integrity result, and collection of sidelink assistance data error for computing the sidelink positioning integrity result.

In aspects of sidelink positioning integrity results, this disclosure details solutions that enable corrective measures and/or actions upon reception of the sidelink positioning integrity results based on location estimates derived from sidelink positioning in order to enhance sidelink positioning reliability. Implementations include enabling sidelink positioning integrity KPIs and integrity result reporting (e.g., utilizing a positioning reporting message) with and without location server involvement, and provisioning real-time integrity alerts to UEs performing sidelink positioning.

One or more of the described implementations may be combined with each other to support integrity and reliable positioning over the SL (PC5) interface. As used herein, a positioning-related reference signal may be referred to as a reference signal used for positioning procedures or purposes in order to estimate a target-UE's location, such as a PRS, or based on existing reference signals such as CSI-RS or SRS. A target-UE may be referred to as the device or entity to be localized and/or positioned. In various implementations, the term PRS may refer to any signal, such as a reference signal, which may or may not be used primarily for positioning. Additionally, any reference made to position, location information, and/or estimates may refer to an absolute position or a relative position with respect to another node or entity, ranging in terms of distance, ranging in terms of direction, or combination thereof.

In an implementation for UE-based sidelink positioning integrity support, a UE computing a positioning estimate based on sidelink RAT-dependent positioning measurements is enabled to compute the integrity of the derived UE or target device location or position estimate based on received assistance information from relevant network entities. Examples of sidelink RAT-dependent positioning methods include SL-TDOA, including DL-TDOA like measurements, such as SL-RSTD and UL-TDOA like methods such as SL-RTOA, RTT type techniques including single-sided RTT, double-sided RTT, multi-UE RTT, SL-AOA, SL-AOD, and SL carrier phase positioning schemes. In another implementation, integrity of position estimates derived based on sidelink RAT-independent methods such as GNSS or A-GNSS are also supported.

Based on the SL positioning architecture, different UEs may have the capability to compute the positioning integrity including sidelink positioning by a server UE that computes the location estimate and thus the integrity of the computed location estimate. Note that the server UE may reside in an anchor UE (with or without a known location) or within a target-UE. In other implementations, the server UE may be a standalone UE. A target-UE can compute the location estimate and thus the integrity of the computed location estimate. In further aspects, sidelink integrity is supported for at least two types of UE-based modes of positioning integrity. A UE-based sidelink positioning integrity with a location server (e.g., LMF) targets in-coverage or partial coverage scenarios, assuming a LPP transfer of integrity assistance information (using non-access stratum (NAS) connection) or transferring SLPP messages (e.g., within an LPP container). A UE-based sidelink positioning integrity in a standalone or distributed manner targets partial coverage and out-of-coverage scenarios, assuming SLPP (sidelink positioning protocol) transfer of integrity assistance information.

The integrity at the UE is calculated as a function of the estimated positioning error exceeding a time period defined as the time to alert (TTA). The integrity service parameters may include at least one of the integrity risk parameters, which include residual risk, the integrity risk (IR) lower and upper bounds in order to satisfy the RAT-dependent integrity operation as defined by the following relationship:

P(SL Positioning Error>Bound for longer than TTA|NOT DNU)<=Residual Risk+IRallocation

where TTA is the elapsed time for which the sidelink RAT-dependent positioning error may be higher than the alert limit, before an alarm or warning message is signaled to the sidelink positioning calculation entity, which may include the LMF (location server) for network-assisted positioning methods. In other implementations, the target-UE for UE-based positioning methods, DNU refers to do not use flag, residual risk is the probability of onset, which is defined per unit of time and represents the probability that a feared event begins, and IRallocation is a range of integrity risk defined by the previously mentioned lower and upper bounds. The sidelink positioning integrity results may be calculated in terms of absolute a horizontal or vertical protection level, for achievable TIR in relation to target TIR.

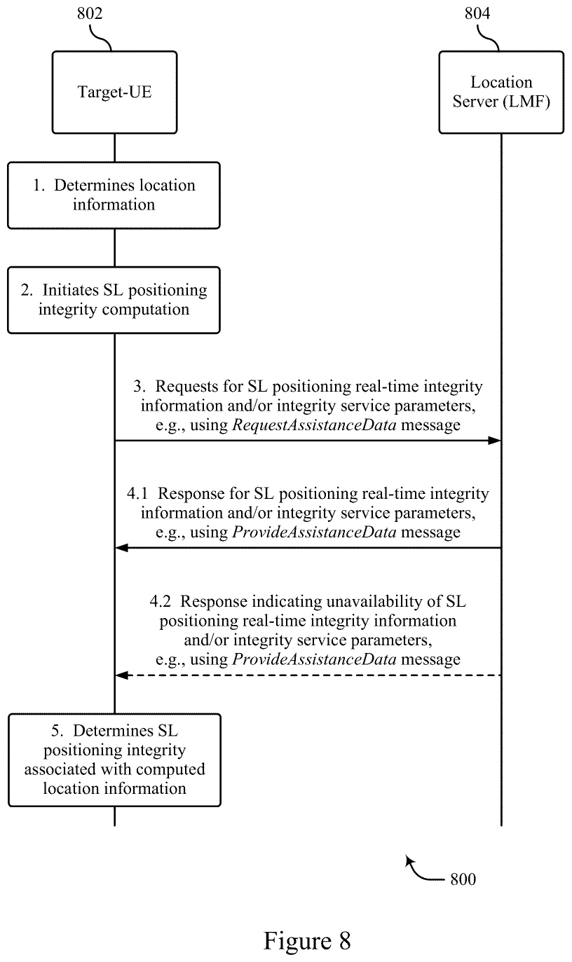

FIG. 8 illustrates an example of a procedure 800 in accordance with aspects of the present disclosure. In this example, the procedure 800 enables sidelink positioning integrity computation for UE-based sidelink positioning integrity with location server involvement, where a target-UE 802 is assumed to be in-coverage. In the procedure message flow, at step 1, the target-UE 802 determines the location information based on prior sidelink positioning procedures. The location information can include absolute, relative, and/or distance or direction-based location information. At step 2, the target-UE initiates the UE-based sidelink positioning integrity computation of the computed location information. At step 3, the target-UE initiates a request to the location server 804 for the provision of sidelink integrity-related information and/or integrity service parameters. For example, the signaling can include the LPP RequestAssistanceData message. The request can also include other meta information related to the provision of sidelink integrity information, including time domain characteristics, such as aperiodic, periodic, and/or an event-triggered provision of such assistance information. At step 4.1, the location server complies with the request to provision sidelink integrity-related information and/or integrity service parameters. At step 4.2, the location server may not comply with the request to provision the sidelink integrity-related information and/or integrity service parameters due to an unavailability of the information and accordingly indicates it in this step. Note that either step 4.1 or step 4.2 has to occur with respect to the request sent in step 3 in the same session, but not both steps 4.1 and 4.2 simultaneously. At step 5, the target-UE can accordingly determine the sidelink positioning integrity results based on the information received in step 4.1.

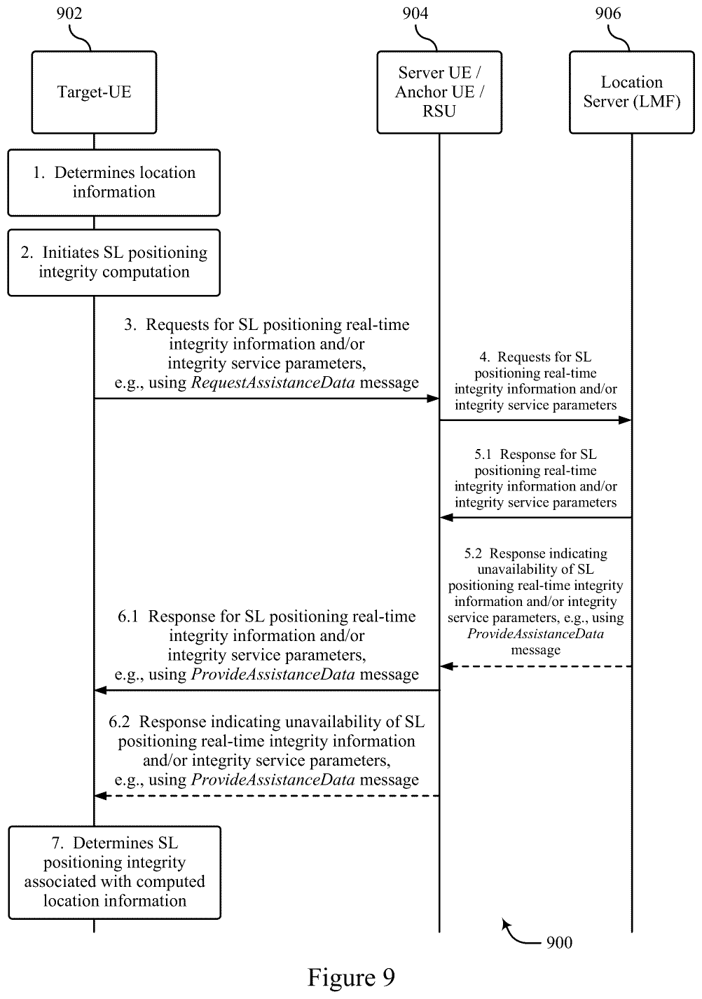

FIG. 9 illustrates an example of a procedure 900 in accordance with aspects of the present disclosure. In this example, the procedure 900 enables sidelink positioning integrity computation for UE-based sidelink positioning integrity with a server UE and a location server involvement, where a target-UE 902 is assumed to be out-of-coverage and the server UE or anchor UE (either identified as 904) is assumed to be in-coverage (e.g., a partial coverage scenario). In the procedure message flow, at step 1, the target-UE 902 determines the location information based on prior sidelink positioning procedures. The location information can include absolute, relative, and/or distance or direction-based location information. At step 2, the target-UE initiates the UE-based sidelink positioning integrity computation of the computed location information. At step 3, the target-UE initiates a request to the server UE or anchor UE (either identified as 904), which is in-coverage, for the provision of sidelink integrity-related information and/or integrity service parameters. Example signaling can include the SLPP RequestAssistanceData message. The request can also include other meta information related to the provision of sidelink integrity information, including time domain characteristics, such as aperiodic, periodic, and/or an event-triggered provision of the assistance information. At step 4, the server UE or anchor UE transmits an associated request to the location server 906 for any sidelink integrity-related information and/or integrity service parameters, if not available at the server UE or anchor UE, on behalf of the target-UE. Example signaling can include the LPP RequestAssistance Data message and may include any identifiers pertaining to the target-UE, including a session identifier (ID), a source ID, a destination ID, a UE-ID, and so forth.

At step 5.1, the location server complies with the request to provision sidelink integrity-related information and/or integrity service parameters for the target-UE, if available. Example signaling can include the LPP ProvideAssistanceData message. At step 5.2, the location server may not comply with the request to provision the sidelink integrity-related information and/or integrity service parameters due to unavailability of the information and accordingly indicates it in this step. Example signaling can include the LPP Error message. At step 6.1, the server UE or anchor UE complies with the request to provision the sidelink integrity-related information and/or integrity service parameters for the target-UE, if available from the location server. Example signaling can include the SLPP ProvideAssistanceData message. At step 6.2, the server UE or anchor UE indicates to the target-UE that the location server cannot comply with the request to provision the sidelink integrity-related information and/or integrity service parameters due to an unavailability of the information from the location server. Example signaling can include the SLPP Error message. At step 7, the target-UE can accordingly determine the sidelink positioning integrity results based on the information received in step 6.1.

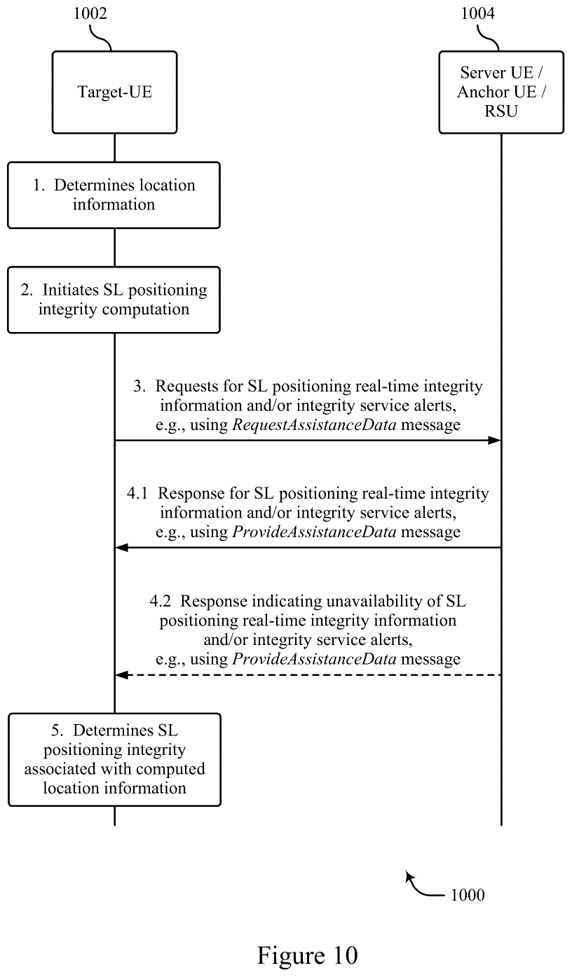

FIG. 10 illustrates an example of a procedure 1000 in accordance with aspects of the present disclosure. In this example, the procedure 1000 enables sidelink positioning integrity computation for UE-based sidelink positioning integrity without location server involvement, where a target-UE 1002 and server UE or anchor-UE (either identified as 1004) is assumed to be out-of-coverage. In the procedure message flow, at step 1, the target-UE 1002 determines the location information based on prior sidelink positioning procedures. The location information can include absolute, relative, and/or distance or direction-based location information. At step 2, the target-UE initiates the UE-based sidelink positioning integrity computation of the computed location information. At step 3, the target-UE initiates a request to the server UE or anchor UE (either identified as 1004), for the provision of sidelink integrity-related information and/or integrity service parameters. Example signaling can include the SLPP RequestAssistance Data message. The request can also include other meta information related to the provision of sidelink integrity information, including time domain characteristics such as aperiodic, periodic, and/or event-triggered provision of the assistance information. At step 4.1, the server UE or anchor UE complies with the request to provision the sidelink integrity-related information and/or integrity service parameters for the target-UE, if available. Example signaling can include the SLPP ProvideAssistanceData message. At step 4.2, the server UE or anchor UE may not comply with the request to provision the sidelink integrity-related information and/or integrity service parameters due to unavailability of such information and accordingly indicates it in this step. Example signaling can include the SLPP Error message. At step 5, the target-UE can accordingly determine the sidelink positioning integrity results based on the information received in Step 4.1.

In another aspect of the implementation, the sidelink positioning integrity may apply to location estimates derived using RAT-dependent positioning methods, RAT-independent positioning methods, or a combination thereof. Examples of the RAT-dependent positioning methods include SL-TDOA, SL-RTT (single-sided or double-sided), SL-AOA and SL-AOD. Examples of the RAT-independent positioning methods include A-GNSS/GNSS positioning, WLAN, Bluetooth, UWB, TBS, IMU sensors, etc.

In an implementation for LMF-based sidelink positioning integrity support, and similar to the implementations described with reference to FIGS. 8-10, the location server (e.g., LMF) is supported to compute the sidelink positioning integrity results. Therefore, a location server computing a positioning estimate based on sidelink RAT-dependent positioning measurements and/or Uu RAT-dependent measurements is enabled to compute the integrity of the derived UE or target device location or position estimate based on internally available integrity assistance information or received integrity assistance information from relevant network entities or UEs.

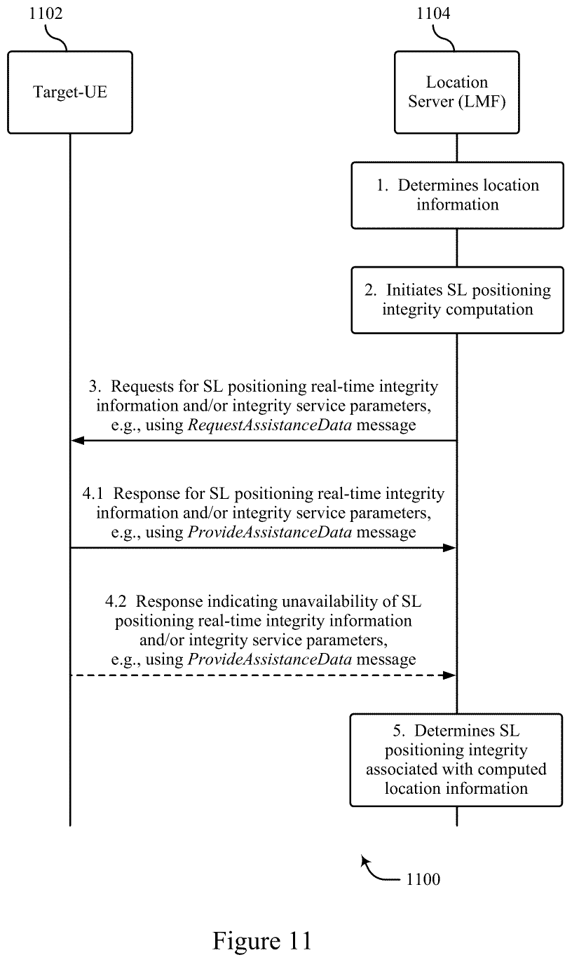

FIG. 11 illustrates an example of a procedure 1100 in accordance with aspects of the present disclosure. In this example, the procedure 1100 enables sidelink positioning integrity computation for UE-based sidelink positioning integrity with location server involvement, where a target-UE 1102 is assumed to be in-coverage. As described with reference to FIG. 8, the steps 1, 2, and 5 can occur at the location server 1104 and can internally make use of any integrity service-related information to compute the sidelink positioning integrity results of the target-UE. If the integrity service-related information is not available within the location server, the location server can initiate a request to one or more UEs participating the sidelink positioning session with the target-UE.

In the procedure message flow, at step 1, the location server 1104 determines the location information based on prior sidelink positioning procedures. The location information can include absolute, relative, and/or distance or direction-based location information. At step 2, the location server initiates the LMF-based sidelink positioning integrity computation of the computed location information. At step 3, the location server initiates a request to the target-UE 1102 for the sidelink integrity-related information and/or integrity service parameters. At step 4.1, the target-UE complies with the request to provide sidelink integrity-related information and/or integrity service parameters. At step 4.2, the target-UE may not comply with the request to provide the sidelink integrity-related information and/or integrity service parameters due to an unavailability of the information and accordingly indicates it in this step. Note that either step 4.1 or step 4.2 occurs with respect to the request sent in step 3 in the same session, but not both steps 4.1 and 4.2 simultaneously. At step 5, the location server can accordingly determine the sidelink positioning integrity results based on the information received in step 4.1.

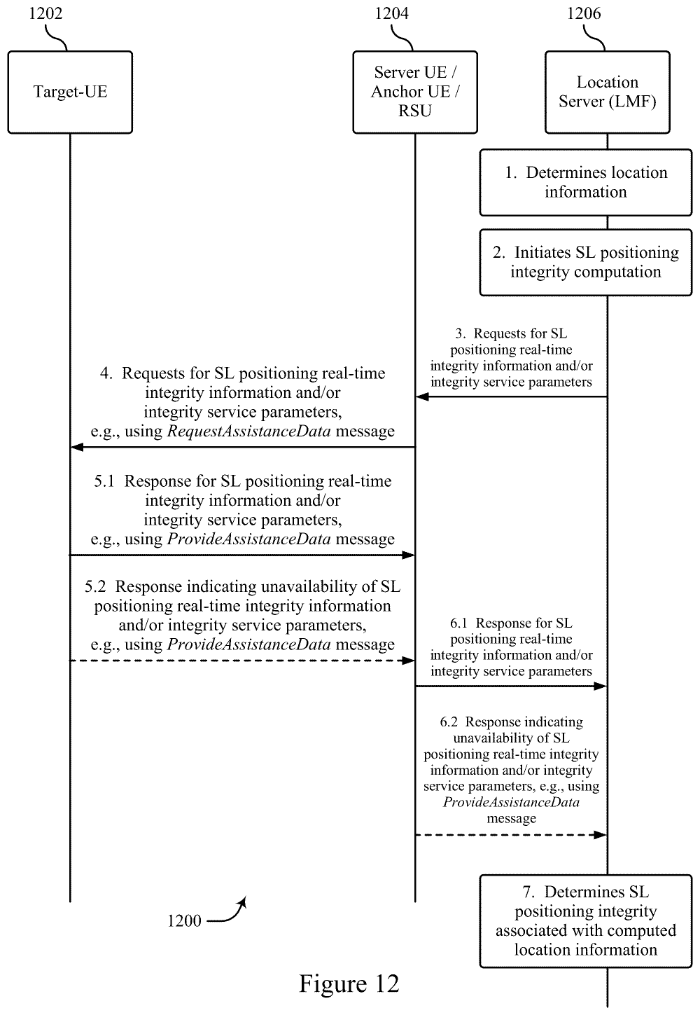

FIG. 12 illustrates an example of a procedure 1200 in accordance with aspects of the present disclosure. In this example, the procedure 1200 enables sidelink positioning integrity computation for UE-based sidelink positioning integrity with a server UE and a location server involvement, where a target-UE 1202 is assumed to be out-of-coverage and the server UE or anchor UE (either identified as 1204) is assumed to be in-coverage (e.g., a partial coverage scenario). As described with reference to FIG. 9, the steps 1, 2, and 7 can occur at the location server 1206 and can internally make use of any integrity service-related information to compute the sidelink positioning integrity results of the target-UE. If the integrity service-related information is not available within the location server, the location server can initiate a request to one or more UEs participating the sidelink positioning session with the target-UE.

In the procedure message flow, at step 1, the location server 1206 determines the location information based on prior sidelink positioning procedures. The location information can include absolute, relative, and/or distance or direction-based location information. At step 2, the location server initiates the LMF-based sidelink positioning integrity computation of the computed location information. At step 3, the location server initiates a request to the server UE or anchor UE (either identified as 1204), which is in-coverage, for the provision of sidelink integrity-related information and/or integrity service parameters. At step 4, the server UE or anchor UE transmits an associated request to the target-UE for any sidelink integrity-related information and/or integrity service parameters, if not available at the server UE or anchor UE, on behalf of the location server.

At step 5.1, the target-UE complies with the request to provide sidelink integrity-related information and/or integrity service parameters for the location server, if available. At step 5.2, the target-UE may not comply with the request to provide the sidelink integrity-related information and/or integrity service parameters due to unavailability of the information and accordingly indicates it in this step. At step 6.1, the server UE or anchor UE complies with the request to provide the sidelink integrity-related information and/or integrity service parameters to the location server, if available from the target-UE. At step 6.2, the server UE or anchor UE indicates to the location server that the target-UE cannot comply with the request to provide the sidelink integrity-related information and/or integrity service parameters due to an unavailability of the information from the target-UE. At step 7, the location server can accordingly determine the sidelink positioning integrity results based on the information received in step 6.1.

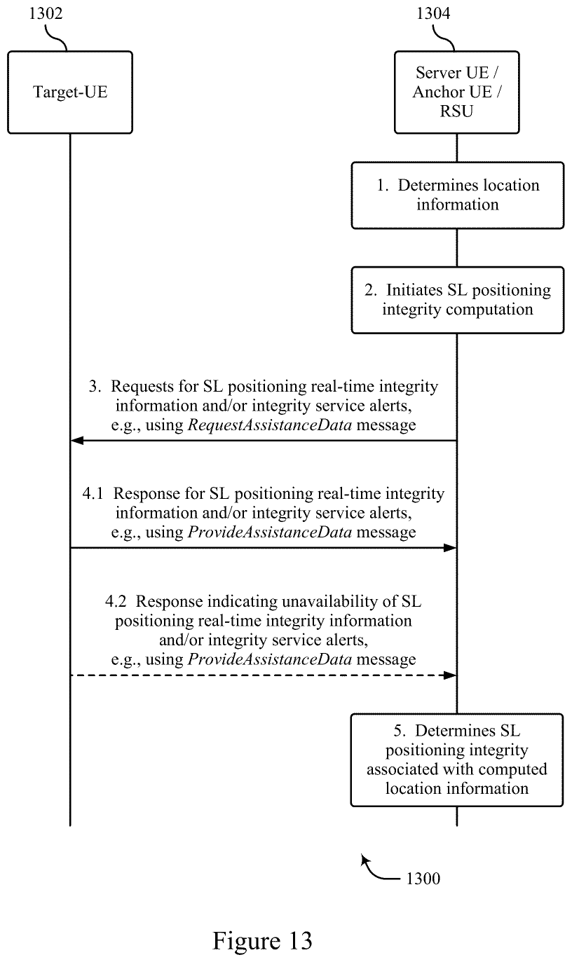

FIG. 13 illustrates an example of a procedure 1300 in accordance with aspects of the present disclosure. In this example, the procedure 1300 enables sidelink positioning integrity computation for UE-based sidelink positioning integrity without location server involvement, where a target-UE 1302 and server UE or anchor UE (either identified as 1304) is assumed to be out-of-coverage. In the procedure message flow, at step 1, the server UE or anchor UE determines the location information based on prior sidelink positioning procedures. The location information can include absolute, relative, and/or distance or direction-based location information. At step 2, the server UE or anchor UE initiates the UE-based sidelink positioning integrity computation of the computed location information. At step 3, the server UE or anchor UE initiates a request to the target-UE for provision of the sidelink integrity-related information and/or integrity service parameters. At step 4.1, the target-UE complies with the request to provide the sidelink integrity-related information and/or integrity service parameters for the server UE or anchor UE, if available. At step 4.2, the target-UE may not comply with the request to provide the sidelink integrity-related information and/or integrity service parameters due to unavailability of the information and accordingly indicates it in this step. At step 5, the server UE or anchor UE target-UE can accordingly determine the sidelink positioning integrity results based on the information received in Step 4.1.

With reference to sidelink positioning integrity measurement error sources, sidelink RAT-dependent integrity error source characterization can be an important step in the overall calculation of the integrity result. In the case of UE-based and LMF-based sidelink positioning integrity, error sources may be classified as sidelink positioning measurement errors or sidelink positioning assistance data errors. Measurement errors in sidelink positioning integrity refer to inaccuracies or uncertainties in the measurements made by the UE, target device, and/or RSU used to determine the position of a UE or device. These errors can arise from various sources and can impact the reliability and accuracy of the position estimation. Example error sources include measurement noise, multipath effects and NLOS effects of the measured signal, bias and calibration errors, synchronization errors, and so forth.

TABLE
SL RAT-dependent measurement error sources mapped to positioning techniques.

| SL Positioning Method | Measurement Error | Error Distribution and Parameters |
|---|---|---|
| SL-TDoA | SL RSTD | Normal (Gaussian)/ |
| (DL-like method) | | Paired overbounding Gaussian Distribution |
| | | (Mean, Standard deviation |
| SL-TDoA | SL RTOA | Normal (Gaussian)/ |
| (UL-like method) | | Paired overbounding Gaussian Distribution |
| | | (Mean, Standard deviation |
| SL-RTT | UE Rx-Tx time difference | Normal (Gaussian)/ |
| | | Paired overbounding Gaussian Distribution |
| | | (Mean, Standard deviation |
| SL-AoA | SL-AoA(Azimuth-of-Arrival)/ | Normal (Gaussian)/ |
| | ZoA (Zenith of Arrival) | Paired overbounding Gaussian Distribution |
| | | (Mean, Standard deviation |
| SL-TDoA/SL-RTT/ | SL PRS RSRP | Normal (Gaussian)/ |
| SL-AoA | SL PRS RSRPP | Paired overbounding Gaussian Distribution |
| | | (Mean, Standard deviation |
| SL-AoD | SL Phase difference of Arrival | Normal (Gaussian)/ |
| | | Paired overbounding Gaussian Distribution |
| | | (Mean, Standard deviation |

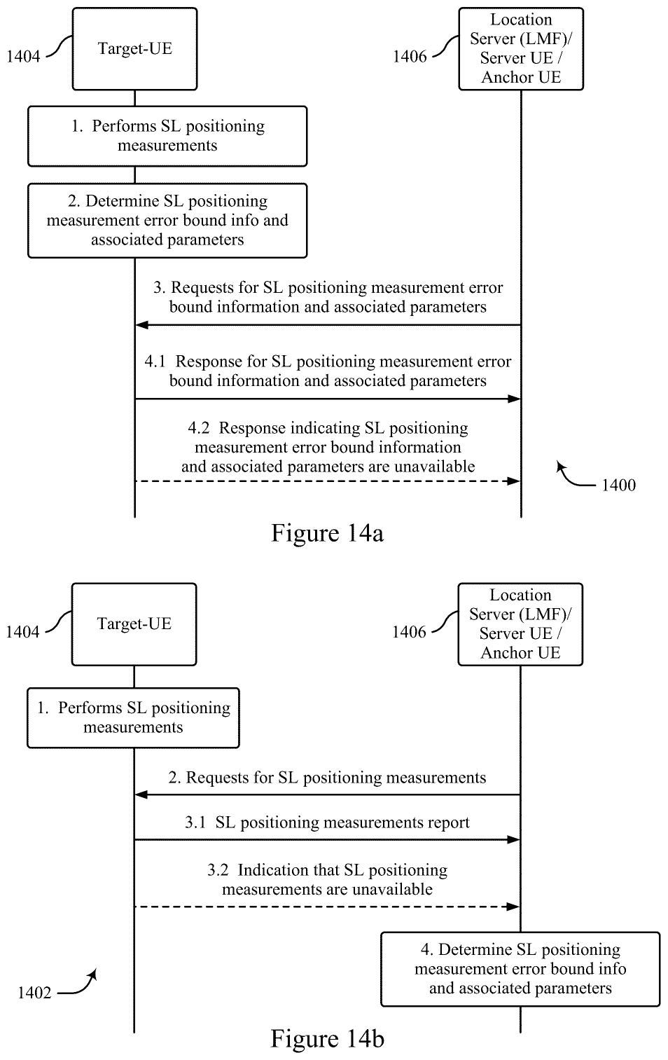

FIG. 14a illustrates an example of a procedure 1400 in accordance with aspects of the present disclosure. FIG. 14b illustrates an example of a procedure 1402 in accordance with aspects of the present disclosure. In these examples, the messaging flow for the sidelink positioning measurement collection and determination is shown. In the procedure 1400, the target-UE 1404 (a UE performing the sidelink positioning measurements) may determine the sidelink positioning measurement error bound information and associated parameters. These parameters can include statistical parameters, such as mean, variance, standard deviation, and so forth of the measurement errors. In the procedure 1402, the sidelink positioning measurement error bound information and associated parameters are determined at the location server, server UE, or anchor UE (any of which are identified as 1406) upon reception of the sidelink positioning measurement report (e.g., as realized by the table above). In another implementation, the measurement error may apply to RAT-independent measurements such as A-GNSS data exchanged over sidelink.

With reference to sidelink positioning integrity assistance data error sources, sidelink RAT-dependent integrity error source characterization can be an important step in the overall calculation of the integrity result. In the case of UE-based and LMF-based sidelink positioning integrity, error sources may be classified as sidelink positioning assistance data errors. Assistance data errors arise from any errors or issues resulting from the provision of certain assistance data elements from a configuration entity, such as a location server, or server UE or anchor UE.

TABLE
SL RAT-dependent assistance data error sources mapped to positioning techniques.

| SL Positioning Method | Assistance Data (AD) Error | Error Distribution and Parameters |
|---|---|---|
| SL-TDoA/SL-AoD/ | Anchor UE Location Information | Normal (Gaussian)/ |
| SL-AoA | | Paired overbounding Gaussian Distribution |
| | | (Mean, Standard deviation |
| SL-TDoA | SFN (System Frame Number) or DEN | Normal (Gaussian)/ |
| | (Direct Frame Number) Initialization | Paired overbounding Gaussian Distribution |
| | time | (Mean, Standard deviation |
| SL-TDoA | RTD (Real time difference) or Inter- | Normal (Gaussian)/ |
| | UE synchronization | Paired overbounding Gaussian Distribution |
| | | (Mean, Standard deviation |
| SL-AoA | SL ARP Location Information | Normal (Gaussian)/ |
| | | Paired overbounding Gaussian Distribution |
| | | (Mean, Standard deviation |
| SL-AoD | SL PRS Beam Information - This AD | Normal (Gaussian)/ |
| | element is used by the server UE or | Paired overbounding Gaussian Distribution |
| | Anchor UE or location server to | (Mean, Standard deviation |
| | provide spatial direction information of | |
| | the SL-PRS Resources | |
| | SL PRS TRP Antenna Information - | |
| | This AD element provides the relative | |
| | SL-PRS Resource power between PRS | |
| | resources per angle per TRP of the UE | |

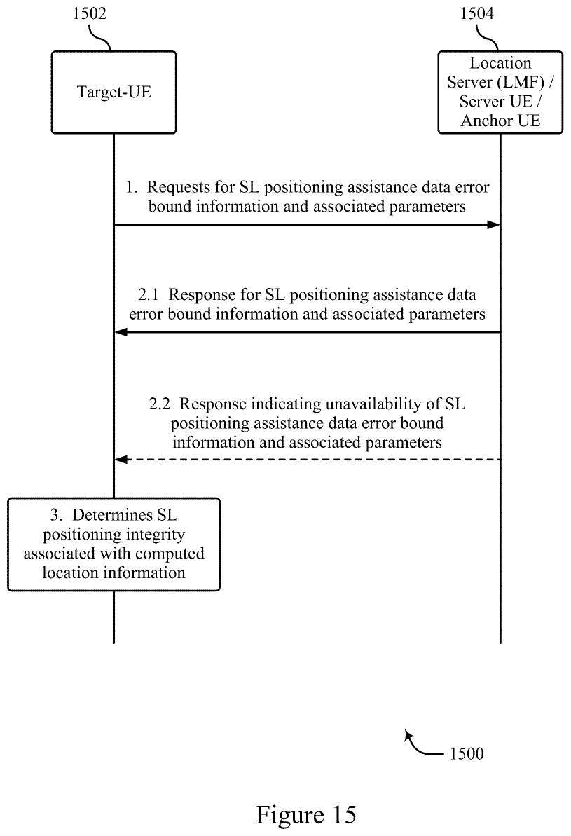

FIG. 15 illustrates an example of a procedure 1500 in accordance with aspects of the present disclosure. In this example, the messaging flow for the sidelink positioning assistance data error collection needed to compute the sidelink positioning integrity at the UE-side is shown. In other aspects of one or more of the described implementations other error distributions and parameters may also be associated with the measurement errors and assistance data errors including, for example, uniform distribution with a mean and variance. In the procedure message flow, at step 1, the target-UE 1502 requests sidelink positioning assistance data error bound information and associated parameters from the location server (LMF), server UE, or anchor UE (any of which is identified as 1504). At step 2, the location server (LMF), server UE, or anchor UE provides a response for the sidelink positioning assistance data error bound information and associated parameters to the target-UE. At step 3, the location server (LMF), server UE, or anchor UE may indicate that the information is not available. At step 4, the target-UE determines the sidelink positioning integrity associated with a computed location information.

With reference to sidelink positioning integrity KPIs and result reporting, a UE computing a positioning estimate based on sidelink positioning measurements are enabled to report the integrity of the derived UE or target device location or position estimate based on received assistance information and request from the relevant network or UE entities. Examples of sidelink RAT-dependent positioning methods include SL-TDOA, including DL-TDOA like measurements such as SL-RSTD and UL-TDoA like methods and SL-RTOA, RTT type techniques including single-sided RTT, double-sided RTT, multi-UE RTT, SL-AOA, SL-AOD, and SL carrier phase positioning schemes. In another implementation, integrity results of position estimates based on sidelink RAT-independent methods such as GNSS or A-GNSS are also supported to be reported. Upon completion of the integrity computation, the integrity results may be reported (e.g., in a positioning reporting message) to a requesting entity such as a location services (LCS) client, LMF, server UE, and/or anchor UE.

Based on the sidelink positioning architecture, different UEs may have the capability of requesting and reporting the positioning integrity results including, for sidelink positioning, a server UE that computes the location estimate and thus the integrity of the computed location estimate. Note that the server UE may reside in an anchor UE (with or without a known location) or within a target-UE. In other implementations, the server UE may be standalone UE. An anchor UE can request the sidelink positioning integrity results from the target-UE. The target-UE is computing the location estimate and thus the integrity of this computed location estimate. According to the described aspects, sidelink positioning integrity results reporting is supported for two types of UE-based modes of positioning integrity. For example, UE-based sidelink positioning integrity with a location server (e.g., LMF) for targets in-coverage or partial coverage scenarios, and assuming an LTE positioning protocol (LPP) transfer of integrity assistance information (using non-access stratum (NAS) connection) or transferring SLPP messages within a LPP container. In another example, a UE-based sidelink positioning integrity in a standalone or distributed manner targets partial coverage and out-of-coverage scenarios, and assuming SLPP (sidelink positioning protocol) transfer of integrity assistance information.

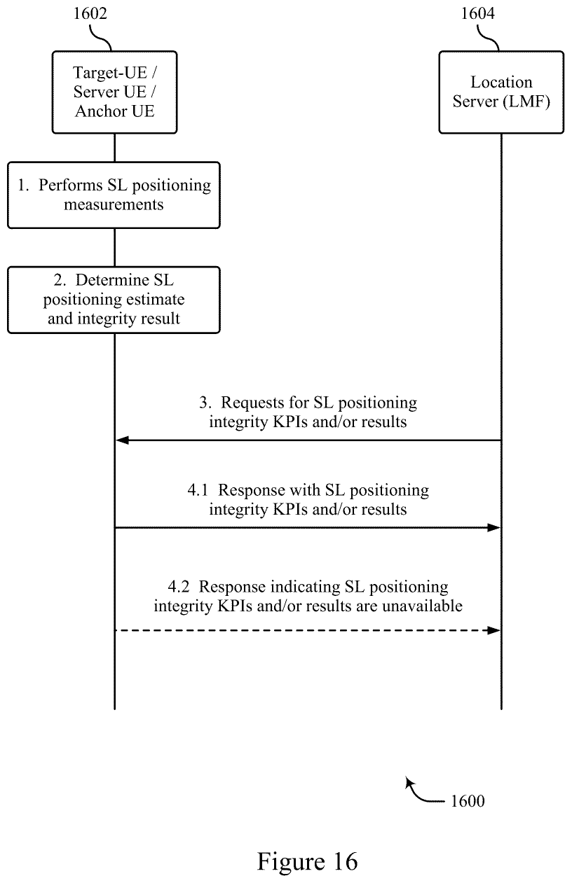

FIG. 16 illustrates an example of a procedure 1600 in accordance with aspects of the present disclosure. In this example, a high-level procedure is shown for enabling sidelink positioning integrity KPIs and/or results for UE-based sidelink positioning integrity with location server involvement, where the target-UE, server UE, or anchor UE (any of which are identified as 1602) is assumed to be in-coverage. In the procedure message flow, at step 1, the target-UE or device performs sidelink positioning measurements based on the received sidelink positioning configuration. At step 2, the target-UE or device computes the location estimate and determines the sidelink positioning integrity based on the computed location estimate. At step 3, the location server 1604 initiates a request to the target-UE or device to provision the sidelink positioning integrity KPIs and/or integrity results via a UE measurement report. The sidelink positioning integrity KPIs can include the TTA, AL, TIR, or combination thereof while the sidelink positioning integrity results may include the protection levels depending on the location information request type (e.g., absolute or relative). Example signaling can include the LPP RequestLocationInformation message to transfer the request. The request can also include other meta information related to provisioning the sidelink positioning integrity KPIs and/or integrity results information, including time domain characteristics, such as aperiodic, periodic, and/or event-triggered provision of the integrity results reporting. In other implementations, ID information, such as a source ID, a destination ID, or any other UE identifying information (UE-IDs) (e.g., 5G-S-TMSI of the target-UE or device) and its positioning counterpart UEs of the same session (same session ID) (e.g., server UE, anchor UE, client UE, and so forth).

At step 4.1, the target-UE or device complies with the request to provision the sidelink positioning integrity KPIs and/or results via a measurement report including at least one of absolute horizontal or vertical protection level (value range in meters), relative horizontal or vertical protection level (value range in meters), horizontal distance protection level (value range in meters), vertical distance protection level (value range in meters), azimuth angle of arrival protection level (value range in degrees/radians), zenith angle of arrival protection level (value range in degrees/radians), achievable target integrity risk (TIR) in relation to target TIR, where P (TIR)=10^{-0.1n} [hour⁻¹] where n is the value of achievable TIR and the range is 10⁻¹ to 10⁻⁹ per hour. Additionally, the TTA (in time units) and AL (in meters) may also be provided. In another implementation, the request message from the location server can include of a subset of the aforementioned sidelink positioning integrity results. Example signaling can include the LPP Provide LocationInformation message to transfer sidelink positioning integrity results to the location server.

At step 4.2, the target-UE or device may not comply with the request to provision the sidelink positioning integrity KPIs and/or results due to an unavailability of the information or other error causes (e.g., failure of sidelink positioning integrity calculation and accordingly indicates it in this step). Example signaling can include the LPP Error message to transfer the error cause associated with the unavailability of the sidelink positioning integrity results to the location server. Noting that either step 4.1 or step 4.2 may occur with respect to the request sent in step 3 in the same session, but not both steps 4.1 and 4.2 simultaneously.

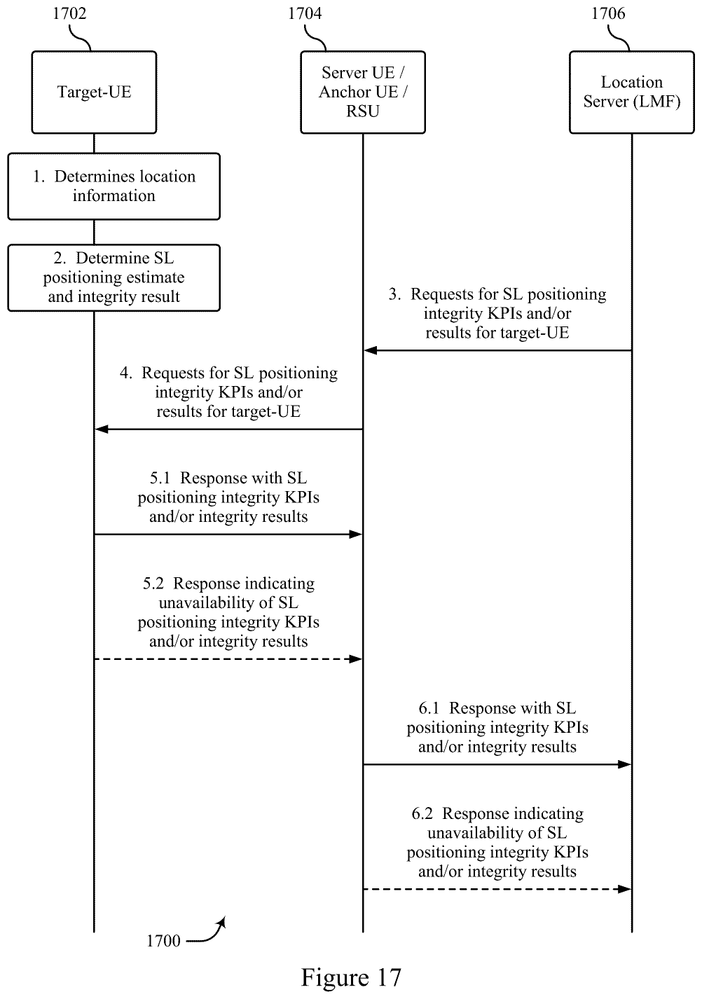

FIG. 17 illustrates an example of a procedure 1700 in accordance with aspects of the present disclosure. In this example, a high-level procedure is shown for enabling sidelink positioning integrity KPIs and/or results reporting for UE-based sidelink positioning integrity with server UE and location server involvement, where a target-UE 1702 is assumed to be out-of-coverage and the server UE or anchor UE (either identified as 1704) is assumed to be in-coverage (a partial coverage scenario) with connection with the location server 1706. In the procedure message flow, at step 1, the target-UE or device performs the sidelink positioning measurements based on the received sidelink positioning configuration. At step 2, the target-UE or device computes the location estimate and determines the sidelink positioning integrity based on the computed location estimate.

At step 3, the location server initiates a request to the server UE or anchor UE, which is in-coverage, for the provision of sidelink positioning integrity KPIs and/or integrity results. The sidelink positioning integrity KPIs can include the TTA, AL, TIR, or combination thereof, while the sidelink positioning integrity results may include the protection levels depending on the location information request type (e.g., absolute or relative). Example signaling can include the LPP RequestLocationInformation message. The request can also include other meta information related to provisioning the sidelink integrity information, including time domain characteristics such as aperiodic, periodic, and/or an event-triggered provision of the assistance information. In other implementations, ID information, such as a source ID, a destination ID, or any other UE identifying information (UE-IDs) (e.g., 5G-S-TMSI of the target-UE or device) and its positioning counterpart UEs of the same session (same session ID) (e.g., server UE, anchor UE, client UE, and so forth). The request can also include the type of integrity KPIs and/or results to be reported (e.g., a type of protection level, TIR).

At step 4, the server UE or anchor UE transmits the associated or same request received from the location server to the target-UE for the sidelink positioning integrity results. Example signaling can include the SLPP RequestAssistanceData message and may also contain any identifiers pertaining to the target-UE, including a session ID, a source ID, a destination ID, a UE-ID (e.g., 5G-S-TMSI number), and so forth. At step 5.1, the location server complies with the request to provision the sidelink integrity-related information and/or integrity service parameters for the target-UE, if available. Example signaling can include the LPP ProvideAssistanceData message. At step 5.2, the location server may not comply with the request to provision the sidelink integrity-related information and/or integrity service parameters due to unavailability of the information, and accordingly indicates it in this step. Example signaling can include the LPP Error message. AT step 6.1, the server UE or anchor UE complies with the request to provision the sidelink integrity-related information and/or integrity service parameters for the target-UE, if available from the location server. Example signaling can include the SLPP ProvideAssistanceData message. At step 6.2, the location server may not comply with the request to provision the sidelink integrity-related information and/or integrity service parameters due to unavailability of such information from the location server, and accordingly indicates it in this step. Example signaling may include the SLPP Error message.

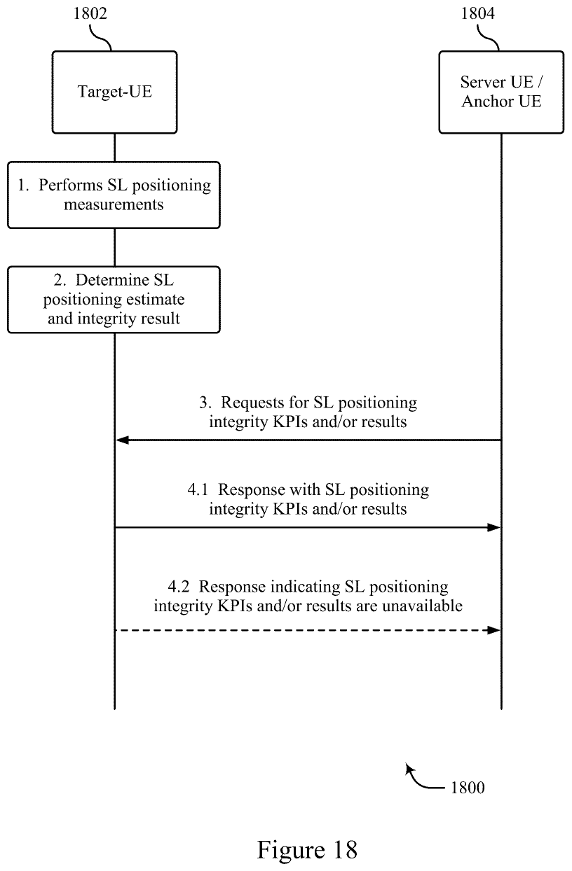

FIG. 18 illustrates an example of a procedure 1800 in accordance with aspects of the present disclosure. In this example, a high-level procedure is shown for enabling sidelink positioning integrity KPIs and/or results reporting for UE-based sidelink positioning integrity without location server involvement, where a target-UE 1802, and a server UE or anchor-UE (either identified as 1804) is assumed to be out-of-coverage. In the procedure message flow, at step 1, the target-UE 1802 or device performs sidelink positioning measurements based on the received sidelink positioning configuration. At step 2, the target-UE or device and computes the location estimate and determines the sidelink positioning integrity based on the computed location estimate. At step 3, the server UE or anchor UE (either identified as 1804) initiates a request to the target-UE or device for the provision of sidelink positioning integrity KPIs and/or integrity results via a UE measurement report. The sidelink positioning integrity KPIs can include the TTA, AL, TIR, or combination thereof while the sidelink positioning integrity results can include the protection levels depending on the location information request type (e.g., absolute or relative). Example signaling can include the LPP RequestLocationInformation message to transfer the request. The request can also include other meta information related to the provisioning of the sidelink positioning integrity KPIs and/or integrity results information, including time domain characteristics, such as aperiodic, periodic, and/or event-triggered provision of the integrity results reporting. In other implementations, ID information, such as a source ID, a destination ID, or any other UE identifying information (UE-IDs) (e.g., 5G-S-TMSI of the target-UE or device) and its positioning counterpart UEs of the same session (same session ID) (e.g., a server UE, anchor UE, client UE, and so forth).

At step 4.1, the target-UE or device complies with the request to provision the sidelink positioning integrity KPIs and/or results via a measurement report that includes at least one of an absolute horizontal or vertical protection level (value range in meters), a relative horizontal or vertical protection level (value range in meters), a horizontal distance protection level (value range in meters), a vertical distance protection level (value range in meters), an azimuth angle of arrival protection level (value range in degrees/radians), a zenith angle of arrival protection level (value range in degrees/radians), an achievable TIR in relation to a target TIR, where P (TIR)=10^{-0.1n} [hour⁻¹] where n is the value of achievable TIR and the range is 10⁻¹ to 10⁻⁹ per hour. Additionally, the TTA (in time units) and AL (in meters) may also be provided. In another implementation, the request message from the location server can include a subset of the aforementioned sidelink positioning integrity results. Example signaling can include the LPP ProvideLocationInformation message to transfer the sidelink positioning integrity results to the location server.

At step 4.2, the target-UE or device may not comply with the request to provision the sidelink positioning integrity KPIs and/or results due to an unavailability of the information or other error causes (e.g., a failure of sidelink positioning integrity calculation and accordingly indicates it in this step). Example signaling can include the LPP Error message to transfer the error cause associated to the unavailability of sidelink positioning integrity results to the location server. Noting that either step 4.1 or step 4.2 can occur with respect to the request sent in step 3 in the same session, but not both steps 4.1 and 4.2 simultaneously.

According to another aspect of the implementation, the sidelink positioning integrity KPIs and/or integrity results may apply to location estimates derived using RAT-dependent positioning methods, RAT-independent positioning methods, or a combination thereof. Examples of RAT-dependent positioning methods include SL-TDOA, SL-RTT (single-sided or double-sided), SL-AOA and SL-AOD. Examples of RAT-independent positioning methods include A-GNSS/GNSS positioning, WLAN, Bluetooth, UWB, TBS, IMU sensors, etc. According to another aspect of the implementation, the request for the sidelink positioning integrity KPIs and/or integrity results reporting can include additional parameters, such as an indication of whether the sidelink positioning service is unavailable (e.g., using a flag), an indication of the duration that a sidelink positioning service is unavailable (e.g., as Boolean values), an indication of whether there is a loss in sidelink positioning integrity and the loss quantity, and/or an indication of the type of reporting mode (e.g., Mode 1 or Mode 2 integrity results reporting).

In aspects of the described techniques, and with reference to sidelink positioning real-time integrity transfer, the sidelink positioning integrity conditions are a function of the alert limit and protection level, where the alert limit is defined as the maximum allowable sidelink positioning error such that the positioning system is available for the intended application. If the sidelink positioning error (SPE) is beyond the AL, the positioning system should be declared unavailable for the intended application to prevent loss of positioning integrity and where the protection level is defined as the statistical upper-bound of the SPE that ensures that, the probability per unit of time of the true error being greater than the AL and the PL being less than or equal to the AL, for longer than the TTA, is less than the required TIR. Accordingly, the PL satisfies the following inequality:

Prob per unit of time [((SPE>AL) & (PL<=AL)) for longer than TTA]<required TIR

In one or more implementations, the SL-PRS configuration entity may configure or re-configure the sidelink positioning assistance data based on the above received integrity results and/or integrity KPIs as shown in the equation. This may include an explicit and/or implicit received indication. The SL-PRS configuration entity can include the location server, base station (gNB), server UE, anchor UE, to (re-) configure the SL-PRS time frequency resources based on the received sidelink positioning integrity results. An explicit configuration may involve the use of a DNU flag, which may be associated to assistance data elements, such as an anchor UE location, SL-PRS resources including SL-PRS resource IDs, SL-PRS dedicated resource pool, or SL-PRS shared or common resource pool. In other implementations, an implicit configuration may involve the omission of such assistance data elements from a SL-PRS assistance data message to the UE (e.g., omission of the relevant IEs from the SLPP ProvideAssistanceData message).

According to an aspect of the implementation, the base station (e.g., a gNB) may transmit a message to the target-UE, server UE, or anchor UE indicating which of the SL-PRS resources and associated granularity should not be measured, which will result in a loss in positioning integrity. In some implementations, this may be based on an existing SL-PRS configuration already available at the UE, while in other implementations it may be based on a pre-configured SL-PRS configuration (positioning assistance data). This message may be transmitted in response to a request sent by the target-UE, server UE, or anchor UE for such information. In another implementation, the LMF may inform the serving NG-RAN node or base station of the adapted SL-PRS configuration via the NRPPa interface, which may be applicable for in-coverage scenarios. In another implementation, and for distributed resource allocation of SL-PRS, the exclusion of SL-PRS resources may be integrated into the existing sensing and selection procedure of SL-PRS. The candidate resources may be already excluded based on not satisfying the sidelink positioning integrity conditions.

In another implementation, this sidelink positioning integrity configuration message can also inform the target-UE, server UE, or anchor UE that SL-PRS assistance data elements are not suitable for the sidelink positioning integrity computation via DNU flags. The gNB may signal the SL-PRS resources not to be measured in one or more combinations in granularity including sidelink positioning frequency layer (PFLs), SL-TRP, SL-PRS dedicated resource pool or SL-PRS shared or common resource pool, a SL-PRS resource set, and/or SL-PRS resources. Each of the above may be used in combination with another to uniquely identify a SL-PRS measurement not to be used for sidelink positioning integrity calculation purposes and therefore may be associated with a DNU flag. In addition, each of the resource granularity indications may have an associated ID.

The above explicit exclusion of resources may be signaled to the UE using, for example, UE-specific signaling from a gNB (e.g., using RRC messages). According to this implementation, the gNB or TRP may directly inform the UE about the SL-PRS resources which are suitable or unsuitable for measurement, and the gNB can transmit the updated sidelink positioning assistance data to the target-UE. In another implementation, the base station may broadcast to multiple UEs using a posSIB or normal SIB, and this may be a common SL-PRS configuration and/or additionally include which of the resources can and/or cannot be used for measurement purposes and/or for positioning integrity purposes (e.g., for integrity calculations). The SL-PRS resources to be excluded may also be signaled per a positioning method or in other implementations, or may be signaled as a common information element across a plurality of positioning methods. In this case, the UE described may be one of a target-UE, server UE, or anchor UE.

In another implementation, implicit signaling can be used by the base station in order to enable a UE not to measure the affected SL-PRS resources for integrity computation, including exclusion of the affected SL-PRS resources from the SL-PRS configuration message from the base station to a target-UE or device, or server UE, or anchor UE. Alternately, or in addition, the target-UE may also transmit an indication to the base station, server UE, or anchor UE (e.g., using the RRC or SLPP messages) to indicate to these entities about providing only suitable SL-PRS assistance data, for the purposes of integrity calculation, and thereafter the target-UE may regard all received assistance data as available for integrity calculation. In another implementation, the target-UE may exclude certain SL-PRS resources to be measured according to previously received one or more UE measurement reports. These measurement reports can include SL-RTOA, SL-RSTD, sidelink UE Rx-Tx time difference measurements, SL-PRS RSRP, SL-PRS RSRPP measurements, or the like.

According to another implementation, the issued DNU flags for one or more sidelink positioning assistance data elements may be associated with a validity duration, which can be signaled from the LMF. The validity duration can be signaled in time units of milliseconds, seconds, minutes, hours, and so forth. In another implementation, the DNU validity may be based on an event (e.g., the UE leaves a particular zone, such as based on the change of zone ID, a particular cell or area, or entering or leaving a validity area). In another implementation, the DNU validity may align with the normal SIB or posSIB expiration time, or in some other implementations a separate DNU validity may not be configured and will be equivalent to the normal SIB or posSIB expiration time. In implementations, the issued DNU flags may be applicable to pre-configured positioning assistance data, if configured. The DNU may also extend to validity areas, which may result in a loss of positioning or not be considered for the integrity computations.

According to another implementation, the SL-PRS configuration entity may signal a real-time sidelink positioning integrity information message to the target-UE associated with each of the SL-PRS assistance data elements regarding which of the configured resources (including PFLs, TRPs, sidelink resource pools, SL-PRS resource sets, SL-PRS resources) to avoid that which may result in a loss of integrity. In another implementation, this message may also inform the target-UE that SL-PRS assistance data elements are not suitable for the positioning integrity computation. Examples may include TRPs or Tx/Rx beams or SL-PRS transmissions, which are deemed to be NLOS, have a high degree of multipath, high frequency of beam failure, UE or devices which are on the cell-edge, or experience poor connectivity and so forth. According to another implementation, the SL-PRS configuration entity may also provide a list of UEs (e.g., an anchor UE with poor or bad SL-PRS transmission and/or reception quality), where the list may be updated dynamically according to the real-time channel conditions. In an extended implementation, the SL-PRS configuration entity can also provide the specific SL-PRS resource granularity according to which of the SL-PRS and associated measurements are not suitable for integrity calculation. The support for sidelink positioning real-time integrity information exchange may be subject to UE capability.

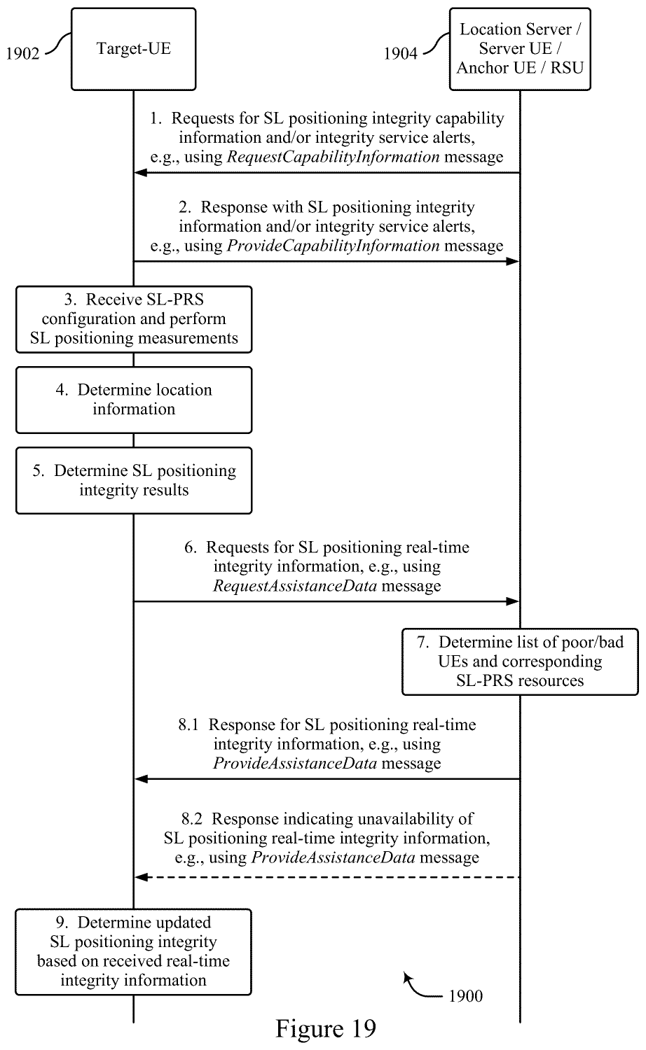

FIG. 19 illustrates an example of a procedure 1900 in accordance with aspects of the present disclosure. In this example, a procedure for signaling flow relating sidelink real-time positioning integrity information exchange between a target-UE 1902 and a location server, or server UE, anchor UE, or RSU (any of which are identified as 1904) is shown. In the procedure message flow, at step 1, the location server, server UE, or anchor UE requests the capabilities regarding real-time sidelink positioning integrity information. Depending on the communication end point, LPP may be used for communication between the target-UE and location server, or between two UEs, SLPP signaling may be used. This also extends to the request for capabilities related to sidelink positioning integrity service parameters, as well as sidelink positioning integrity service alerts.

At step 2, the target-UE or device provides the requested sidelink positioning integrity capabilities based on the received sidelink positioning integrity capability request. At step 3, the target-UE or device receives SL-PRS configuration and performs subsequent SL positioning measurements. At step 4, the target-UE or device determines the sidelink positioning location information. At step 5, the target-UE or device determines the sidelink positioning integrity results of the computed location information. At step 6, the target-UE or device requests for real-time sidelink positioning integrity information. This request may contain the type of real-time integrity information, including the list of poor or bad UEs (e.g., anchor UEs within the same sidelink positioning session).

At step 7, the SL-PRS configuration entity determines the list of undesirable UEs with poor SL-PRS transmission. In another implementation, the base station can determine the list of undesirable UEs with poor or bad SL-PRS transmissions. In the case of RAT-independent positioning, the configuration entity may determine the list of bad or poor satellites, when utilizing A-GNSS or GNSS positioning. At step 8.1, the SL-PRS configuration entity provides the real-time integrity information including the list of poor or bad UEs with poor SL-PRS transmission links and/or the SL-PRS resources associated to each UE not suitable for positioning integrity computation. Example signaling may include the ProvideAssistanceData message used for LPP or SLPP. At step 8.2, the SL-PRS configuration entity indicates the unavailability of real-time integrity information via an error message (e.g., an LPP or SLPP Error message).

According to another implementation, the DNU flags may be applied to all error sources associated with the sidelink positioning assistance data elements. These may include, but are not limited to, anchor UE location information, SFN or DFN initialization time, RTD or inter-UE synchronization info, SL-ARP location information, SL-AOD beam information, and/or SL-PRS TRP antenna information. In another implementation, the DNU flags may also apply to RAT-independent positioning assistance data elements such as A-GNSS or GNSS. This may extend to ionospheric and tropospheric GNSS assistance data elements, which may include integrity service alerts.

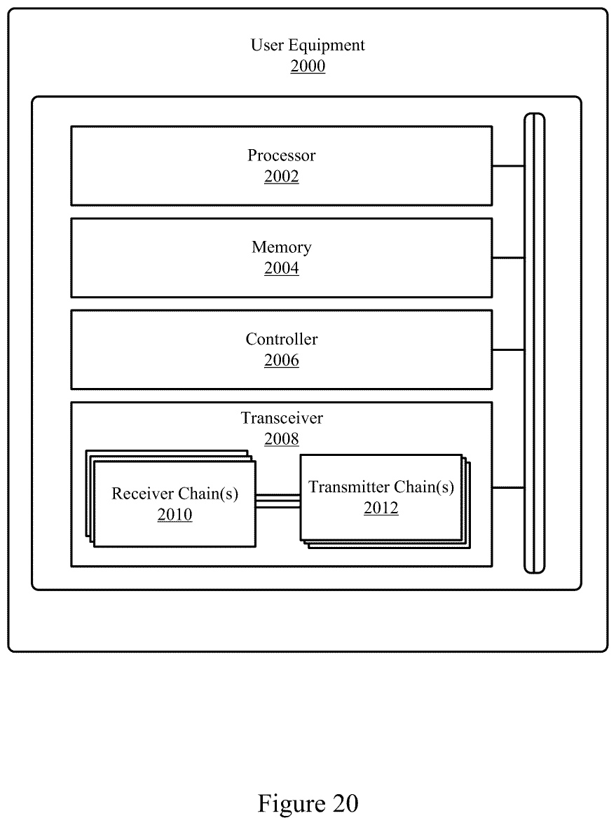

FIG. 20 illustrates an example of a UE 2000 in accordance with aspects of the present disclosure. The UE 2000 may include a processor 2002, a memory 2004, a controller 2006, and a transceiver 2008. The processor 2002, the memory 2004, the controller 2006, or the transceiver 2008, or various combinations thereof or various components thereof may be examples of means for performing various aspects of the present disclosure as described herein. These components may be coupled (e.g., operatively, communicatively, functionally, electronically, electrically) via one or more interfaces.

The processor 2002, the memory 2004, the controller 2006, or the transceiver 2008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2002 may include an intelligent hardware device (e.g., a general-purpose processor, a DSP, a CPU, an ASIC, an FPGA, or any combination thereof). In some implementations, the processor 2002 may be configured to operate the memory 2004. In some other implementations, the memory 2004 may be integrated into the processor 2002. The processor 2002 may be configured to execute computer-readable instructions stored in the memory 2004 to cause the UE 2000 to perform various functions of the present disclosure.

The memory 2004 may include volatile or non-volatile memory. The memory 2004 may store computer-readable, computer-executable code including instructions when executed by the processor 2002 cause the UE 2000 to perform various functions described herein. The code may be stored in a non-transitory computer-readable medium such as the memory 2004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2002 and the memory 2004 coupled with the processor 2002 may be configured to cause the UE 2000 to perform one or more of the functions described herein (e.g., executing, by the processor 2002, instructions stored in the memory 2004). For example, the processor 2002 may support wireless communication at the UE 2000 in accordance with examples as disclosed herein. The UE 2000 may be configured to or operable to support a means for transmitting, to a communication device, a configuration request message to request sidelink positioning integrity information, the configuration request message including at least integrity service parameters; receiving, from the communication device, a response message that includes the requested sidelink positioning integrity information; and determining sidelink positioning integrity of a computed location estimate based at least in part on the received sidelink positioning integrity information.

Additionally, the UE 2000 may be configured to support any one or combination of the UE includes at least one of a target-UE, a server UE, or an anchor UE. The communication device includes at least one of a location server, a server UE, or an anchor UE. The sidelink positioning integrity information includes real-time integrity information. The integrity service parameters include at least one of a residual risk, an upper bound of integrity risk allocation, or a lower bound of the integrity risk allocation. The configuration request message includes the request for at least one of measurement error bound information and associated parameters of the measurement error bound information, or assistance error bound information and associated parameters of the assistance error bound information. A determination of the sidelink positioning integrity supports a UE-based sidelink positioning integrity result and a LMF-based sidelink positioning integrity result. The method further comprising utilizing at least one of LPP messages or SLPP request assistance data and provide assistance data messages to exchange the sidelink positioning integrity information. The method further comprising utilizing at least one of sidelink RAT-dependent positioning methods or sidelink RAT-independent positioning methods for the determining the sidelink positioning integrity. The sidelink RAT-dependent positioning methods include at least one of sidelink TDOA, single-sided sidelink RTT, double-sided sidelink RTT, sidelink AOA, or sidelink AOD. The sidelink RAT-independent positioning methods include at least one of GNSS positioning, A-GNSS positioning, WLAN, Bluetooth, UWB, TBS, or IMU sensors.

Additionally, or alternatively, the UE 2000 may support at least one memory; and at least one processor coupled with the at least one memory and configured to cause the UE to: transmit, to a communication device, a configuration request message to request sidelink positioning integrity information, the configuration request message including at least integrity service parameters; receive, from the communication device, a response message that includes the requested sidelink positioning integrity information; and determine sidelink positioning integrity of a computed location estimate based at least in part on the received sidelink positioning integrity information.

Additionally, the UE 2000 may be configured to support any one or combination of the UE includes at least one of a target-UE, a server UE, or an anchor UE. The communication device includes at least one of a location server, a server UE, or an anchor UE. The sidelink positioning integrity information includes real-time integrity information. The integrity service parameters include at least one of a residual risk, an upper bound of integrity risk allocation, or a lower bound of the integrity risk allocation. The configuration request message includes the request for at least one of measurement error bound information and associated parameters of the measurement error bound information, or assistance error bound information and associated parameters of the assistance error bound information. A determination of the sidelink positioning integrity supports a UE-based sidelink positioning integrity result and a LMF-based sidelink positioning integrity result. The at least one processor is configured to cause the UE to utilize at least one of LPP messages or SLPP request assistance data and provide assistance data messages to exchange the sidelink positioning integrity information. The at least one processor is configured to cause the UE to utilize at least one of sidelink RAT-dependent positioning methods or sidelink RAT-independent positioning methods to determine the sidelink positioning integrity. The sidelink RAT-dependent positioning methods include at least one of sidelink TDOA, single-sided sidelink RTT, double-sided sidelink RTT, sidelink AOA, or sidelink AOD. The sidelink RAT-independent positioning methods include at least one of GNSS positioning, A-GNSS positioning, WLAN, Bluetooth, UWB, TBS, or IMU sensors.

In some implementations, the processor 2002 and the memory 2004 coupled with the processor 2002 may be configured to cause the UE 2000 to perform one or more of the functions described herein (e.g., executing, by the processor 2002, instructions stored in the memory 2004). For example, the processor 2002 may support wireless communication at the UE 2000 in accordance with examples as disclosed herein. The UE 2000 may be configured to or operable to support a means for receiving, from a communication device, a request message to request sidelink positioning integrity KPIs and sidelink positioning integrity results, the request message including at least an indication of TIR and a protection level; and transmitting, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

Additionally, the UE 2000 may be configured to support any one or combination of the communication device includes at least one of a location server, a server UE, or an anchor UE. The UE is at least one of a target-UE, a server UE, or an anchor UE. The sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The method further comprising transmitting, to the communication device, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The method further comprising causing the UE to receive real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

Additionally, or alternatively, the UE 2000 may support at least one memory; and at least one processor coupled with the at least one memory and configured to cause the UE to: receive, from a communication device, a request message to request sidelink positioning integrity KPIs and sidelink positioning integrity results, the request message including at least an indication of TIR and a protection level; and transmit, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

Additionally, the UE 2000 may be configured to support any one or combination of the communication device includes at least one of a location server, a server UE, or an anchor UE. The UE is at least one of a target-UE, a server UE, or an anchor UE. The sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The at least one processor is configured to cause the UE to transmit, to the communication device, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The at least one processor is configured to cause the UE to receive real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

The controller 2006 may manage input and output signals for the UE 2000. The controller 2006 may also manage peripherals not integrated into the UE 2000. In some implementations, the controller 2006 may utilize an operating system such as iOS®, ANDROID®, WINDOWS®, or other operating systems. In some implementations, the controller 2006 may be implemented as part of the processor 2002.

In some implementations, the UE 2000 may include at least one transceiver 2008. In some other implementations, the UE 2000 may have more than one transceiver 2008. The transceiver 2008 may represent a wireless transceiver. The transceiver 2008 may include one or more receiver chains 2010, one or more transmitter chains 2012, or a combination thereof.

A receiver chain 2010 may be configured to receive signals (e.g., control information, data, packets) over a wireless medium. For example, the receiver chain 2010 may include one or more antennas to receive a signal over the air or wireless medium. The receiver chain 2010 may include at least one amplifier (e.g., a low-noise amplifier (LNA)) configured to amplify the received signal. The receiver chain 2010 may include at least one demodulator configured to demodulate the receive signal and obtain the transmitted data by reversing the modulation technique applied during transmission of the signal. The receiver chain 2010 may include at least one decoder for decoding the demodulated signal to receive the transmitted data.

A transmitter chain 2012 may be configured to generate and transmit signals (e.g., control information, data, packets). The transmitter chain 2012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2012 may also include at least one power amplifier configured to amplify the modulated signal to an appropriate power level suitable for transmission over the wireless medium. The transmitter chain 2012 may also include one or more antennas for transmitting the amplified signal into the air or wireless medium.

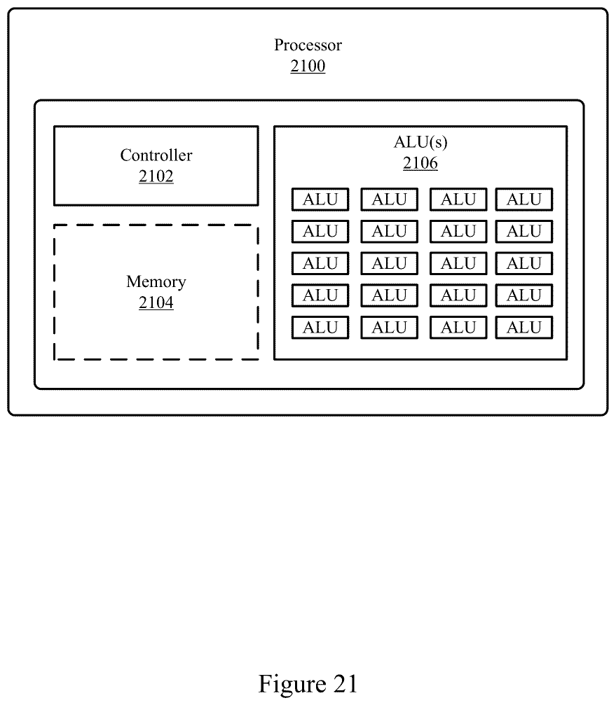

FIG. 21 illustrates an example of a processor 2100 in accordance with aspects of the present disclosure. The processor 2100 may be an example of a processor configured to perform various operations in accordance with examples as described herein. The processor 2100 may include a controller 2102 configured to perform various operations in accordance with examples as described herein. The processor 2100 may optionally include at least one memory 2104, which may be, for example, an L1/L2/L3 cache. Additionally, or alternatively, the processor 2100 may optionally include one or more arithmetic-logic units (ALUs) 2106. One or more of these components may be in electronic communication or otherwise coupled (e.g., operatively, communicatively, functionally, electronically, electrically) via one or more interfaces (e.g., buses).

The processor 2100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2102 may be configured to manage and coordinate various operations (e.g., signaling, receiving, obtaining, retrieving, transmitting, outputting, forwarding, storing, determining, identifying, accessing, writing, reading) of the processor 2100 to cause the processor 2100 to support various operations in accordance with examples as described herein. For example, the controller 2102 may operate as a control unit of the processor 2100, generating control signals that manage the operation of various components of the processor 2100. These control signals include enabling or disabling functional units, selecting data paths, initiating memory access, and coordinating timing of operations.

The controller 2102 may be configured to fetch (e.g., obtain, retrieve, receive) instructions from the memory 2104 and determine subsequent instruction(s) to be executed to cause the processor 2100 to support various operations in accordance with examples as described herein. The controller 2102 may be configured to track memory addresses of instructions associated with the memory 2104. The controller 2102 may be configured to decode instructions to determine the operation to be performed and the operands involved. For example, the controller 2102 may be configured to interpret the instruction and determine control signals to be output to other components of the processor 2100 to cause the processor 2100 to support various operations in accordance with examples as described herein. Additionally, or alternatively, the controller 2102 may be configured to manage flow of data within the processor 2100. The controller 2102 may be configured to control transfer of data between registers, ALUs 2106, and other functional units of the processor 2100.

The memory 2104 may include one or more caches (e.g., memory local to or included in the processor 2100 or other memory, such as RAM, ROM, DRAM, SDRAM, SRAM, MRAM, flash memory, etc. In some implementations, the memory 2104 may reside within or on a processor chipset (e.g., local to the processor 2100). In some other implementations, the memory 2104 may reside external to the processor chipset (e.g., remote to the processor 2100).

The memory 2104 may store computer-readable, computer-executable code including instructions that, when executed by the processor 2100, cause the processor 2100 to perform various functions described herein. The code may be stored in a non-transitory computer-readable medium such as system memory or another type of memory. The controller 2102 and/or the processor 2100 may be configured to execute computer-readable instructions stored in the memory 2104 to cause the processor 2100 to perform various functions. For example, the processor 2100 and/or the controller 2102 may be coupled with or to the memory 2104, the processor 2100, and the controller 2102, and may be configured to perform various functions described herein. In some examples, the processor 2100 may include multiple processors and the memory 2104 may include multiple memories. One or more of the multiple processors may be coupled with one or more of the multiple memories, which may, individually or collectively, be configured to perform various functions herein.

The one or more ALUs 2106 may be configured to support various operations in accordance with examples as described herein. In some implementations, the one or more ALUs 2106 may reside within or on a processor chipset (e.g., the processor 2100). In some other implementations, the one or more ALUs 2106 may reside external to the processor chipset (e.g., the processor 2100). One or more ALUs 2106 may perform one or more computations such as addition, subtraction, multiplication, and division on data. For example, one or more ALUs 2106 may receive input operands and an operation code, which determines an operation to be executed. One or more ALUs 2106 may be configured with a variety of logical and arithmetic circuits, including adders, subtractors, shifters, and logic gates, to process and manipulate the data according to the operation. Additionally, or alternatively, the one or more ALUs 2106 may support logical operations such as AND, OR, exclusive-OR (XOR), not-OR (NOR), and not-AND (NAND), enabling the one or more ALUs 2106 to handle conditional operations, comparisons, and bitwise operations.

The processor 2100 may support wireless communication in accordance with examples as disclosed herein. The processor 2100 may be configured to or operable to support at least one controller coupled with at least one memory and configured to cause the processor to: transmit a configuration request message to request sidelink positioning integrity information, the configuration request message including at least integrity service parameters; receive a response message that includes the requested sidelink positioning integrity information; and determine sidelink positioning integrity of a computed location estimate based at least in part on the received sidelink positioning integrity information.

Additionally, the processor 2100 may be configured to support any one or combination of the sidelink positioning integrity information includes real-time integrity information. The integrity service parameters include at least one of a residual risk, an upper bound of integrity risk allocation, or a lower bound of the integrity risk allocation. The configuration request message includes the request for at least one of measurement error bound information and associated parameters of the measurement error bound information, or assistance error bound information and associated parameters of the assistance error bound information. A determination of the sidelink positioning integrity supports a UE-based sidelink positioning integrity result and a LMF-based sidelink positioning integrity result. The at least one controller is configured to cause the processor to utilize at least one of LPP messages or SLPP request assistance data and provide assistance data messages to exchange the sidelink positioning integrity information. The at least one controller is configured to cause the processor to utilize at least one of sidelink RAT-dependent positioning methods or sidelink RAT-independent positioning methods to determine the sidelink positioning integrity. The sidelink RAT-dependent positioning methods include at least one of sidelink TDOA, single-sided sidelink RTT, double-sided sidelink RTT, sidelink AOA, or sidelink AOD. The sidelink RAT-independent positioning methods include at least one of GNSS positioning, A-GNSS positioning, WLAN, Bluetooth, UWB, TBS, or IMU sensors.

The processor 2100 may support wireless communication in accordance with examples as disclosed herein. The processor 2100 may be configured to or operable to support at least one controller coupled with at least one memory and configured to cause the processor to: receive a request message to request sidelink positioning integrity KPIs and sidelink positioning integrity results, the request message including at least an indication of TIR and a protection level; and transmit a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

Additionally, the processor 2100 may be configured to support any one or combination of the sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The at least one controller is configured to cause the processor to transmit an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The at least one controller is configured to cause the processor to receive real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

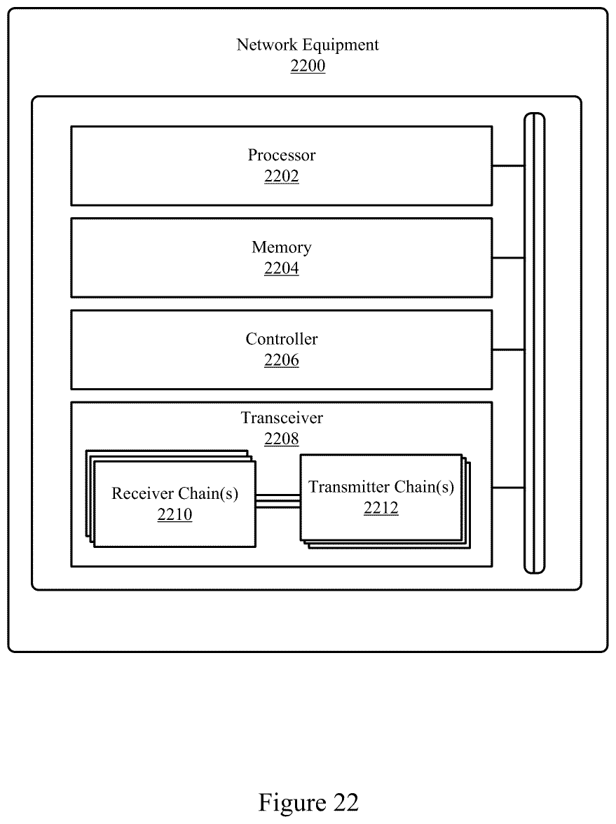

FIG. 22 illustrates an example of a NE 2200 in accordance with aspects of the present disclosure. The NE 2200 may include a processor 2202, a memory 2204, a controller 2206, and a transceiver 2208. The processor 2202, the memory 2204, the controller 2206, or the transceiver 2208, or various combinations thereof or various components thereof may be examples of means for performing various aspects of the present disclosure as described herein. These components may be coupled (e.g., operatively, communicatively, functionally, electronically, electrically) via one or more interfaces.

The processor 2202, the memory 2204, the controller 2206, or the transceiver 2208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2202 may include an intelligent hardware device (e.g., a general-purpose processor, a DSP, a CPU, an ASIC, an FPGA, or any combination thereof). In some implementations, the processor 2202 may be configured to operate the memory 2204. In some other implementations, the memory 2204 may be integrated into the processor 2202. The processor 2202 may be configured to execute computer-readable instructions stored in the memory 2204 to cause the NE 2200 to perform various functions of the present disclosure.

The memory 2204 may include volatile or non-volatile memory. The memory 2204 may store computer-readable, computer-executable code including instructions when executed by the processor 2202 cause the NE 2200 to perform various functions described herein. The code may be stored in a non-transitory computer-readable medium such as the memory 2204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2202 and the memory 2204 coupled with the processor 2202 may be configured to cause the NE 2200 to perform one or more of the functions described herein (e.g., executing, by the processor 2202, instructions stored in the memory 2204). For example, the processor 2202 may support wireless communication at the NE 2200 in accordance with examples as disclosed herein. The NE 2200 may be configured to or operable to support a means for receiving, from a UE, a configuration request message to request sidelink positioning integrity information, the configuration request message including at least integrity service parameters; and transmitting, to the UE, a response message that includes the requested sidelink positioning integrity information from which sidelink positioning integrity of a computed location estimate is determinable based at least in part on the sidelink positioning integrity information.

Additionally, the NE 2200 may be configured to support any one or combination of the UE includes at least one of a target-UE, a server UE, or an anchor UE. The network entity includes at least one of a location server, a server UE, or an anchor UE. The sidelink positioning integrity information includes real-time integrity information. The integrity service parameters include at least one of a residual risk, an upper bound of integrity risk allocation, or a lower bound of the integrity risk allocation. The configuration request message includes the request for at least one of measurement error bound information and associated parameters of the measurement error bound information, or assistance error bound information and associated parameters of the assistance error bound information. A determination of the sidelink positioning integrity supports a UE-based sidelink positioning integrity result and a LMF-based sidelink positioning integrity result. The method further comprising utilizing at least one of LPP messages or SLPP request assistance data and provide assistance data messages to exchange the sidelink positioning integrity information. The method further comprising utilizing at least one of sidelink RAT-dependent positioning methods or sidelink RAT-independent positioning methods to determine the sidelink positioning integrity. The sidelink RAT-dependent positioning methods include at least one of sidelink TDOA, single-sided sidelink RTT, double-sided sidelink RTT, sidelink AOA, or sidelink AOD. The sidelink RAT-independent positioning methods include at least one of GNSS positioning, A-GNSS positioning, WLAN, Bluetooth, UWB, TBS, or IMU sensors.

Additionally, or alternatively, the NE 2200 may support at least one memory; and at least one processor coupled with the at least one memory and configured to cause the network entity to: receive, from a UE, a configuration request message to request sidelink positioning integrity information, the configuration request message including at least integrity service parameters; and transmit, to the UE, a response message that includes the requested sidelink positioning integrity information, from which sidelink positioning integrity of a computed location estimate is determinable based at least in part on the sidelink positioning integrity information.

Additionally, the NE 2200 may be configured to support any one or combination of the UE includes at least one of a target-UE, a server UE, or an anchor UE. The network entity includes at least one of a location server, a server UE, or an anchor UE. The sidelink positioning integrity information includes real-time integrity information. The integrity service parameters include at least one of a residual risk, an upper bound of integrity risk allocation, or a lower bound of the integrity risk allocation. The configuration request message includes the request for at least one of measurement error bound information and associated parameters of the measurement error bound information, or assistance error bound information and associated parameters of the assistance error bound information. A determination of the sidelink positioning integrity supports a UE-based sidelink positioning integrity result and a LMF-based sidelink positioning integrity result. The at least one processor is configured to cause the network entity to utilize at least one of LPP messages or SLPP request assistance data and provide assistance data messages to exchange the sidelink positioning integrity information. The at least one processor is configured to cause the network entity to utilize at least one of sidelink RAT-dependent positioning methods or sidelink RAT-independent positioning methods to determine the sidelink positioning integrity. The sidelink RAT-dependent positioning methods include at least one of sidelink TDOA, single-sided sidelink RTT, double-sided sidelink RTT, sidelink AOA, or sidelink AOD. The sidelink RAT-independent positioning methods include at least one of GNSS positioning, A-GNSS positioning, WLAN, Bluetooth, UWB, TBS, or IMU sensors.

In some implementations, the processor 2202 and the memory 2204 coupled with the processor 2202 may be configured to cause the NE 2200 (e.g., as a location server) to perform one or more of the functions described herein (e.g., executing, by the processor 2202, instructions stored in the memory 2204). For example, the processor 2202 may support wireless communication at the NE 2200 in accordance with examples as disclosed herein. The NE 2200 may be configured to or operable to support a means for transmitting, to a UE, a configuration request message to request sidelink positioning integrity information, the configuration request message including at least integrity service parameters; receiving, from the UE, a response message that includes the requested sidelink positioning integrity information; and determining sidelink positioning integrity of a computed location estimate based at least in part on the received sidelink positioning integrity information.

Additionally, the NE 2200 may be configured to support any one or combination of the UE includes at least one of a target-UE, a server UE, or an anchor UE. The location server includes at least one of a LMF server, a server UE, or an anchor UE. The sidelink positioning integrity information includes real-time integrity information. The integrity service parameters include at least one of a residual risk, an upper bound of integrity risk allocation, or a lower bound of the integrity risk allocation. The configuration request message includes the request for at least one of measurement error bound information and associated parameters of the measurement error bound information, or assistance error bound information and associated parameters of the assistance error bound information. A determination of the sidelink positioning integrity supports a UE-based sidelink positioning integrity result and a LMF-based sidelink positioning integrity result. The method further comprising utilizing at least one of LPP messages or SLPP request assistance data and provide assistance data messages to exchange the sidelink positioning integrity information. The method further comprising utilizing at least one of sidelink RAT-dependent positioning methods or sidelink RAT-independent positioning methods for the determining the sidelink positioning integrity. The sidelink RAT-dependent positioning methods include at least one of sidelink TDOA, single-sided sidelink RTT, double-sided sidelink RTT, sidelink AOA, or sidelink AOD. The sidelink RAT-independent positioning methods include at least one of GNSS positioning, A-GNSS positioning, WLAN, Bluetooth, UWB, TBS, or IMU sensors.

Additionally, or alternatively, the NE 2200 may support at least one memory; and at least one processor coupled with the at least one memory and configured to cause the location server to: transmit, to a UE, a configuration request message to request sidelink positioning integrity information, the configuration request message including at least integrity service parameters; receive, from the UE, a response message that includes the requested sidelink positioning integrity information; and determine sidelink positioning integrity of a computed location estimate based at least in part on the received sidelink positioning integrity information.

Additionally, the NE 2200 may be configured to support any one or combination of the UE includes at least one of a target-UE, a server UE, or an anchor UE. The location server includes at least one of a LMF server, a server UE, or an anchor UE. The sidelink positioning integrity information includes real-time integrity information. The integrity service parameters include at least one of a residual risk, an upper bound of integrity risk allocation, or a lower bound of the integrity risk allocation. The configuration request message includes the request for at least one of measurement error bound information and associated parameters of the measurement error bound information, or assistance error bound information and associated parameters of the assistance error bound information. A determination of the sidelink positioning integrity supports a UE-based sidelink positioning integrity result and a LMF-based sidelink positioning integrity result. The at least one processor is configured to cause the location server to utilize at least one of LPP messages or SLPP request assistance data and provide assistance data messages to exchange the sidelink positioning integrity information. The at least one processor is configured to cause the location server to utilize at least one of sidelink RAT-dependent positioning methods or sidelink RAT-independent positioning methods to determine the sidelink positioning integrity. The sidelink RAT-dependent positioning methods include at least one of sidelink TDOA, single-sided sidelink RTT, double-sided sidelink RTT, sidelink AOA, or sidelink AOD. The sidelink RAT-independent positioning methods include at least one of GNSS positioning, A-GNSS positioning, WLAN, Bluetooth, UWB, TBS, or IMU sensors.

In some implementations, the processor 2202 and the memory 2204 coupled with the processor 2202 may be configured to cause the NE 2200 to perform one or more of the functions described herein (e.g., executing, by the processor 2202, instructions stored in the memory 2204). For example, the processor 2202 may support wireless communication at the NE 2200 in accordance with examples as disclosed herein. The NE 2200 may be configured to or operable to support a means for transmitting, to a UE, a request message to request sidelink positioning integrity KPIs and sidelink positioning integrity results, the request message including at least an indication of TIR and a protection level; receiving, from the UE, a response message that includes the requested sidelink positioning integrity KPIs and the sidelink positioning integrity results; and determining whether sidelink positioning integrity conditions of a computed location estimate are satisfied based at least in part on the received sidelink positioning integrity KPIs and the sidelink positioning integrity results.

Additionally, the NE 2200 may be configured to support any one or combination of the network entity includes at least one of a location server, a server UE, or an anchor UE. The UE is at least one of a target-UE, a server UE, or an anchor UE. The sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The method further comprising receiving, from the UE, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The method further comprising transmitting real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

Additionally, or alternatively, the NE 2200 may support at least one memory; and at least one processor coupled with the at least one memory and configured to cause the network entity to: transmit, to a UE, a request message to request sidelink positioning integrity KPIs and sidelink positioning integrity results, the request message including at least an indication of TIR and a protection level; receive, from the UE, a response message that includes the requested sidelink positioning integrity KPIs and the sidelink positioning integrity results; and determine whether sidelink positioning integrity conditions of a computed location estimate are satisfied based at least in part on the received sidelink positioning integrity KPIs and the sidelink positioning integrity results.

Additionally, the NE 2200 may be configured to support any one or combination of the network entity includes at least one of a location server, a server UE, or an anchor UE. The UE is at least one of a target-UE, a server UE, or an anchor UE. The sidelink positioning integrity KPIs include at least one of a TTA or an alert limit. The TIR includes at least one of an achievable TIR or a target TIR. The protection level includes at least one of: an absolute horizontal protection level value, an absolute vertical protection level value, a relative horizontal protection level value, a vertical protection level value, a horizontal distance protection level value, a vertical distance protection level value, an azimuth AOA protection level value, or a zenith AOA protection level value. The at least one processor is configured to cause the network entity to receive, from the UE, an indication that the requested sidelink positioning integrity KPIs and the sidelink positioning integrity results are unavailable. The response message includes at least one of a first indication of whether a sidelink positioning service is unavailable, a second indication of a duration that the sidelink positioning service is unavailable, or a third indication of a loss of the sidelink positioning integrity. The at least one processor is configured to cause the network entity to transmit real-time sidelink positioning integrity information. The real-time sidelink positioning integrity information includes one or more DNU flags associated with sidelink positioning assistance data elements including one or more of SL-PRS resource configurations, anchor UE location information, SFN initialization time, DFN initialization time, RTD synchronization information, inter-UE synchronization information, sidelink ARP location information, sidelink AOD beam information, or SL-PRS TRP antenna information. Different SL-PRS resource hierarchies include at least one of sidelink positioning frequency layers, sidelink TRPs, SL-PRS resource pools, SL-PRS resource sets, or SL-PRS resources.

The controller 2206 may manage input and output signals for the NE 2200. The controller 2206 may also manage peripherals not integrated into the NE 2200. In some implementations, the controller 2206 may utilize an operating system such as iOS®, ANDROID®, WINDOWS®, or other operating systems. In some implementations, the controller 2206 may be implemented as part of the processor 2202.

In some implementations, the NE 2200 may include at least one transceiver 2208. In some other implementations, the NE 2200 may have more than one transceiver 2208. The transceiver 2208 may represent a wireless transceiver. The transceiver 2208 may include one or more receiver chains 2210, one or more transmitter chains 2212, or a combination thereof.

A receiver chain 2210 may be configured to receive signals (e.g., control information, data, packets) over a wireless medium. For example, the receiver chain 2210 may include one or more antennas to receive a signal over the air or wireless medium. The receiver chain 2210 may include at least one amplifier (e.g., a low-noise amplifier (LNA)) configured to amplify the received signal. The receiver chain 2210 may include at least one demodulator configured to demodulate the receive signal and obtain the transmitted data by reversing the modulation technique applied during transmission of the signal. The receiver chain 2210 may include at least one decoder for decoding the demodulated signal to receive the transmitted data.

A transmitter chain 2212 may be configured to generate and transmit signals (e.g., control information, data, packets). The transmitter chain 2212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2212 may also include at least one power amplifier configured to amplify the modulated signal to an appropriate power level suitable for transmission over the wireless medium. The transmitter chain 2212 may also include one or more antennas for transmitting the amplified signal into the air or wireless medium.

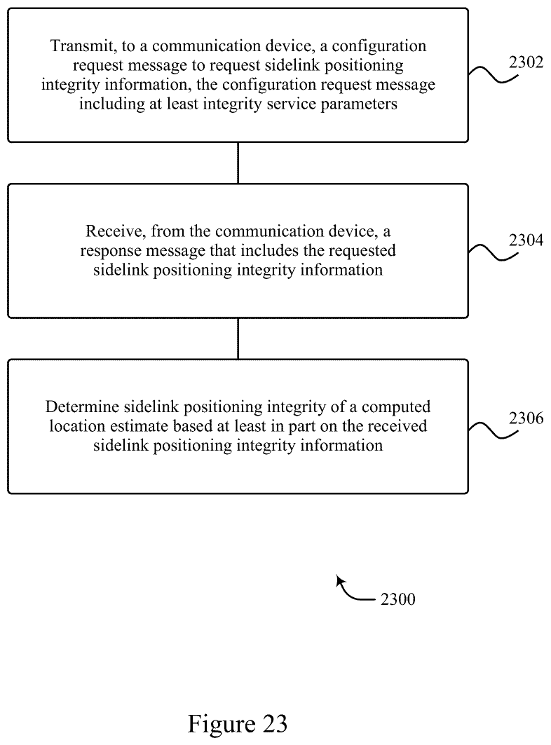

FIG. 23 illustrates a flowchart of a method 2300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 2302, the method may include transmitting, to a communication device, a configuration request message to request sidelink positioning integrity information, the configuration request message including at least integrity service parameters. The operations of 2302 may be performed in accordance with examples as described herein. In some implementations, aspects of the operations of 2302 may be performed by a UE as described with reference to FIG. 20.

At 2304, the method may include receiving, from the communication device, a response message that includes the requested sidelink positioning integrity information. The operations of 2304 may be performed in accordance with examples as described herein. In some implementations, aspects of the operations of 2304 may be performed by a UE as described with reference to FIG. 20.

At 2306, the method may include determining sidelink positioning integrity of a computed location estimate based at least in part on the received sidelink positioning integrity information. The operations of 2306 may be performed in accordance with examples as described herein. In some implementations, aspects of the operations of 2306 may be performed a UE as described with reference to FIG. 20.

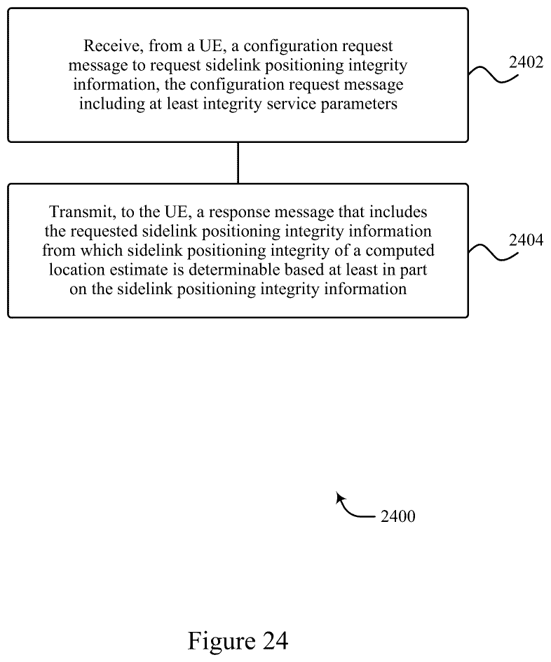

FIG. 24 illustrates a flowchart of a method 2400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2402, the method may include receiving, from a UE, a configuration request message to request sidelink positioning integrity information, the configuration request message including at least integrity service parameters. The operations of 2402 may be performed in accordance with examples as described herein. In some implementations, aspects of the operations of 2402 may be performed by a NE as described with reference to FIG. 22.

At 2404, the method may include transmitting, to the UE, a response message that includes the requested sidelink positioning integrity information from which sidelink positioning integrity of a computed location estimate is determinable based at least in part on the sidelink positioning integrity information. The operations of 2404 may be performed in accordance with examples as described herein. In some implementations, aspects of the operations of 2404 may be performed by a NE as described with reference to FIG. 22.

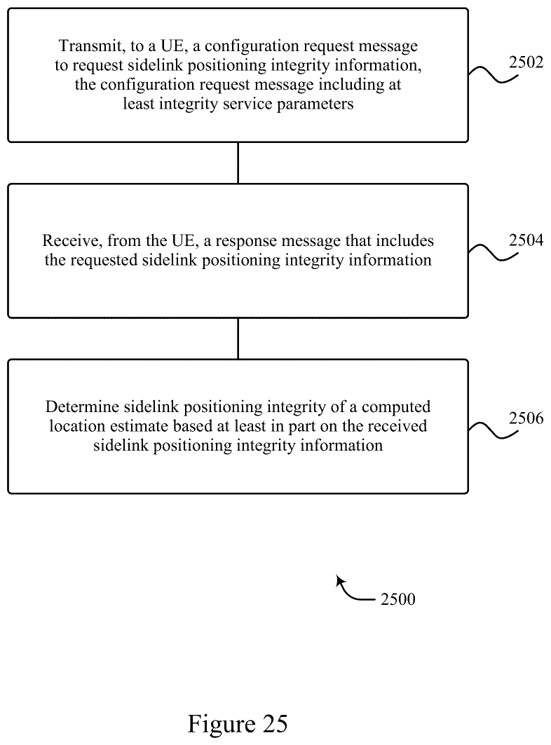

FIG. 25 illustrates a flowchart of a method 2500 in accordance with aspects of the present disclosure. The operations of the method may be implemented by a location server as described herein. In some implementations, the location server may execute a set of instructions to control the function elements of the location server to perform the described functions. It should be noted that the method described herein describes a possible implementation, and that the operations and the steps may be rearranged or otherwise modified and that other implementations are possible.

At 2502, the method may include transmitting, to a UE, a configuration request message to request sidelink positioning integrity information, the configuration request message including at least integrity service parameters. The operations of 2502 may be performed in accordance with examples as described herein. In some implementations, aspects of the operations of 2502 may be performed by a location server as described with reference to FIG. 22 (e.g., a network entity).

At 2504, the method may include receiving, from the UE, a response message that includes the requested sidelink positioning integrity information. The operations of 2504 may be performed in accordance with examples as described herein. In some implementations, aspects of the operations of 2504 may be performed by a location server as described with reference to FIG. 22 (e.g., a network entity).

At 2506, the method may include determining sidelink positioning integrity of a computed location estimate based at least in part on the received sidelink positioning integrity information. The operations of 2506 may be performed in accordance with examples as described herein. In some implementations, aspects of the operations of 2506 may be performed a location server as described with reference to FIG. 22 (e.g., a network entity).

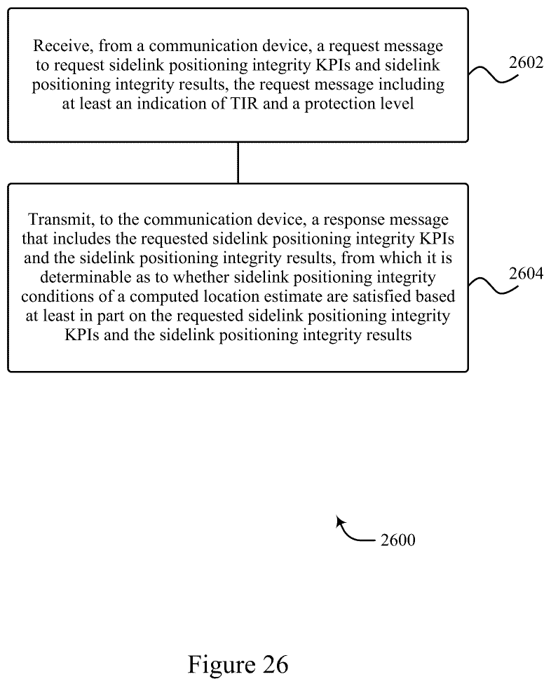

FIG. 26 illustrates a flowchart of a method 2600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 2602, the method may include receiving, from a communication device, a request message to request sidelink positioning integrity KPIs and sidelink positioning integrity results, the request message including at least an indication of TIR and a protection level. The operations of 2602 may be performed in accordance with examples as described herein. In some implementations, aspects of the operations of 2602 may be performed by a UE as described with reference to FIG. 20.

At 2604, the method may include transmitting, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results. The operations of 2604 may be performed in accordance with examples as described herein. In some implementations, aspects of the operations of 2604 may be performed by a UE as described with reference to FIG. 20.

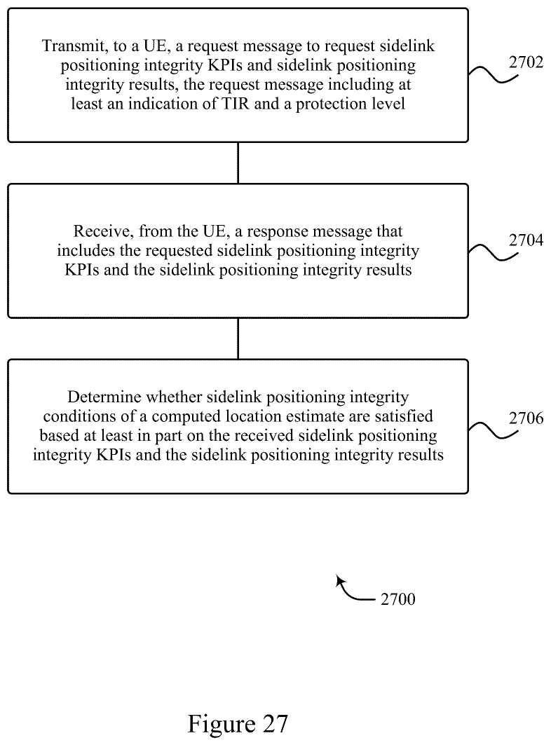

FIG. 27 illustrates a flowchart of a method 2700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2702, the method may include transmitting, to a UE, a request message to request sidelink positioning integrity KPIs and sidelink positioning integrity results, the request message including at least an indication of TIR and a protection level. The operations of 2702 may be performed in accordance with examples as described herein. In some implementations, aspects of the operations of 2702 may be performed by a NE as described with reference to FIG. 22.

At 2704, the method may include receiving, from the UE, a response message that includes the requested sidelink positioning integrity KPIs and the sidelink positioning integrity results. The operations of 2704 may be performed in accordance with examples as described herein. In some implementations, aspects of the operations of 2704 may be performed by a NE as described with reference to FIG. 22.

At 2706, the method may include determining whether sidelink positioning integrity conditions of a computed location estimate are satisfied based at least in part on the received sidelink positioning integrity KPIs and the sidelink positioning integrity results. The operations of 2706 may be performed in accordance with examples as described herein. In some implementations, aspects of the operations of 2706 may be performed a NE as described with reference to FIG. 22.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a communication device, a request message to request sidelink positioning integrity key performance indicators (KPIs) and sidelink positioning integrity results, the request message including at least an indication of target integrity risk (TIR) and a protection level; and
transmit, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

2. The UE of claim 1, wherein the communication device includes at least one of a location server, a server UE, or an anchor UE.

3. The UE of claim 1, wherein the UE is at least one of a target-UE, a server UE, or an anchor UE.

4. The UE of claim 1, wherein the sidelink positioning integrity KPIs include at least one of a time to alert (TTA) or an alert limit.

5. The UE of claim 1, wherein the TIR includes at least one of an achievable TIR or a target TIR.

6. The UE of claim 1, wherein the protection level includes at least one of: an absolute horizontal protection level value, an absolute vertical protection level value, a relative horizontal protection level value, a vertical protection level value, a horizontal distance protection level value, a vertical distance protection level value, an azimuth angle of arrival (AOA) protection level value, or a zenith AOA protection level value.

7. The UE of claim 1, wherein the at least one processor is configured to cause the UE to transmit, to the communication device, an indication that the requested sidelink positioning integrity KPIs and the sidelink positioning integrity results are unavailable.

8. The UE of claim 1, wherein the response message includes at least one of a first indication of whether a sidelink positioning service is unavailable, a second indication of a duration that the sidelink positioning service is unavailable, or a third indication of a loss of the sidelink positioning integrity.

9. The UE of claim 1, wherein the at least one processor is configured to cause the UE to receive real-time sidelink positioning integrity information.

10. The UE of claim 9, wherein the real-time sidelink positioning integrity information includes one or more do not use (DNU) flags associated with sidelink positioning assistance data elements including one or more of sidelink positioning reference signal (SL-PRS) resource configurations, anchor UE location information, system frame number (SFN) initialization time, direct frame number (DFN) initialization time, real time difference (RTD) synchronization information, inter-UE synchronization information, sidelink antenna reference point (ARP) location information, sidelink angle of departure (AOD) beam information, or SL-PRS transmission-reception point (TRP) antenna information.

11. The UE of claim 10, wherein different SL-PRS resource hierarchies include at least one of sidelink positioning frequency layers, sidelink TRPs, SL-PRS resource pools, SL-PRS resource sets, or SL-PRS resources.

12. A processor for wireless communication, comprising:
at least one controller coupled with at least one memory and configured to cause the processor to:
receive a request message to request sidelink positioning integrity key performance indicators (KPIs) and sidelink positioning integrity results, the request message including at least an indication of target integrity risk (TIR) and a protection level; and
transmit a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

13. The processor of claim 12, wherein the sidelink positioning integrity KPIs include at least one of a time to alert (TTA) or an alert limit.

14. The processor of claim 12, wherein the TIR includes at least one of an achievable TIR or a target TIR.

15. The processor of claim 12, wherein the protection level includes at least one of: an absolute horizontal protection level value, an absolute vertical protection level value, a relative horizontal protection level value, a vertical protection level value, a horizontal distance protection level value, a vertical distance protection level value, an azimuth angle of arrival (AOA) protection level value, or a zenith AOA protection level value.

16. The processor of claim 12, wherein the at least one controller is configured to cause the processor to transmit an indication that the requested sidelink positioning integrity KPIs and the sidelink positioning integrity results are unavailable.

17. The processor of claim 12, wherein the response message includes at least one of a first indication of whether a sidelink positioning service is unavailable, a second indication of a duration that the sidelink positioning service is unavailable, or a third indication of a loss of the sidelink positioning integrity.

18. The processor of claim 12, wherein the at least one controller is configured to cause the processor to receive real-time sidelink positioning integrity information.

19. A method performed by a user equipment (UE), the method comprising:
receiving, from a communication device, a request message to request sidelink positioning integrity key performance indicators (KPIs) and sidelink positioning integrity results, the request message including at least an indication of target integrity risk (TIR) and a protection level; and
transmitting, to the communication device, a response message that includes the requested sidelink positioning integrity KPIs and the sidelink positioning integrity results, from which it is determinable as to whether sidelink positioning integrity conditions of a computed location estimate are satisfied based at least in part on the requested sidelink positioning integrity KPIs and the sidelink positioning integrity results.

20. A network entity for wireless communication, comprising:
at least one memory; and
at least one processor coupled with the at least one memory and configured to cause the network entity to:
transmit, to a user equipment (UE), a request message to request sidelink positioning integrity key performance indicators (KPIs) and sidelink positioning integrity results, the request message including at least an indication of target integrity risk (TIR) and a protection level;
receive, from the UE, a response message that includes the requested sidelink positioning integrity KPIs and the sidelink positioning integrity results; and
determine whether sidelink positioning integrity conditions of a computed location estimate are satisfied based at least in part on the received sidelink positioning integrity KPIs and the sidelink positioning integrity results.
